(19) United States
(12) Patent Application Publication
(10) Pub. No.: US 2026/0065406 A1
(43) Pub. Date: Mar. 5, 2026

(54) GRAPHICS PROCESSING

(71) Applicant: Arm Limited, Cambridge (GB)

(72) Inventors: Daren Croxford, Swaffham Prior (GB); Roberto Lopez Mendez, Cambridge (GB); Mina Ivanova Dimova, Great Shelford (GB); Liam James O'Neil, Bedale (GB)

(73) Assignee: Arm Limited, Cambridge (GB)

(21) Appl. No.: 18/818,328

(22) Filed: Aug. 28, 2024

(51) Int. Cl. G06T 1/20

(52) U.S. Cl. CPC G06T 1/20

(57) ABSTRACT

Disclosed is a method of operating a graphics processor to generate a render output. A first initial processing pass is performed to determine visibility information as to which primitive fragments are visible at which sampling positions within the render output. This visibility information is then used to control the order in which sampling positions are processed during a subsequent further processing pass that generates the render output.

### BACKGROUND

The technology described herein relates to graphics processing, and in particular to the operation of a graphics processor (graphics processing unit, “GPU”) when generating a render output.

Graphics processing is normally carried out by first dividing the graphics processing (render) output to be rendered, such as a frame to be displayed, into a number of similar basic components of geometry to allow the graphics processing operations to be more easily carried out. These basic components of geometry may often be referred to graphics “primitives”, and such “primitives” are usually in the form of simple polygons, such as triangles, points, lines, etc. (or groups thereof).

Each primitive (e.g. polygon) is at this stage defined by and represented as a set of vertices. Each vertex for a primitive has associated with it a set of data (such as position, colour, texture and other attributes data) representing the vertex. This “vertex data” is then used, e.g., when rasterising and rendering the primitive(s) to which the vertex relates in order to generate the desired render output of the graphics processing.

Once primitives and their vertices have been generated and defined, they can be processed by the graphics processor, in order to generate the desired graphics processing output (render output/target), such as a frame for display. This basically involves determining which sampling positions of an array of sampling positions associated with the render output area to be processed are covered by a primitive, and then determining a respective output value for each sampling position to represent the primitive at that sampling position (the respective output value for a sampling position thus defining the, e.g., appearance that sampling position should have (in terms of its colour, etc.)). These processes are commonly referred to as rasterising and rendering, respectively. (The term “rasterisation” is sometimes used to mean both primitive conversion to sample positions and rendering. However, herein “rasterisation” will be used to refer to converting primitive data to sampling position addresses only.)

These processes are typically carried out by testing sets of one, or of more than one, sampling position, and then generating for each set of sampling positions found to include a sampling position that is inside (covered by) the primitive in question (being tested), a discrete graphical entity usually referred to as a “fragment” on which the graphics processing operations (such as rendering) are carried out. Covered sampling positions are thus, in effect, processed as fragments that will be used to render the primitive at the sampling positions in question. The “fragments” are the graphical entities that pass through the rendering process (the rendering pipeline). Each fragment that is generated and processed may, e.g., represent a single sampling position or a set of plural sampling positions, depending upon how the graphics processing system is configured.

A “fragment” is therefore effectively (has associated with it) a set of primitive data as interpolated to a given output space sampling position or points of a primitive. It may also include per-primitive and other state data that is required to shade the primitive at the sampling position (fragment position) in question.

Each graphics fragment may typically be the same size and location as a “pixel” of the output (e.g. output frame) (since as the pixels are the singularities in the final display, there may be a one-to-one mapping between the “fragments” the graphics processor operates on (renders) and the pixels of a display). However, it can be the case that there is not a one-to-one correspondence between a fragment and a display pixel, for example where particular forms of post-processing, such as downsampling, are carried out on the rendered image prior to displaying the final image. It is also the case that as multiple fragments, e.g. from different overlapping primitives, at a given location may affect each other (e.g. due to transparency and/or blending), the final pixel output may depend upon plural or all fragments at that pixel location.

Correspondingly, there may be a one-to-one correspondence between the sampling positions and the pixels of a display, but more typically there may not be a one-to-one correspondence between sampling positions and display pixels, as downsampling may be carried out on the rendered sample values to generate the output pixel values for displaying the final image. Similarly, where multiple sampling position values, e.g. from different overlapping primitives, at a given location affect each other (e.g. due to transparency and/or blending), the final pixel output will also depend upon plural overlapping sample values at that pixel location.

It is common in graphics processing systems, as part of the rendering process, to generate output values (e.g. colours) for sampling positions in a render output (e.g. image to be displayed) by applying so-called graphics “textures” or “texture data” to the surfaces to be drawn. Such graphics textures are typically applied by storing an array of texture elements or “texels”, each representing given texture data (such as colour, alpha, luminance and/or light/shadow, etc., values), and then mapping the texels onto the corresponding elements, such as (and typically), a set of sampling positions, for the render output in question (e.g. image to be displayed).

Thus a graphics texture will typically be configured as an array of data elements (texture elements (texels)), each having a corresponding set of texture data stored for it. The texture data for a given position within the texture is then determined by sampling the texture at that position (e.g. by using a suitable interpolation process). The stored arrays of texture elements (data) are typically referred to as “texture maps”.

The texture data is typically stored in (external) (e.g. main) memory. When texture data is needed by a graphics processor (e.g. for rendering an image to be displayed), the texture data required for the rendering process is thus usually first fetched from the memory where it is stored and loaded into a cache (e.g. a texture cache) of or accessible to the graphics processor, with the graphics processor (and in particular the rendering pipeline implemented by the graphics processor) then reading the texture data from the texture cache for use to perform the desired texturing operations.

The texture data is typically stored in the (external) (e.g. main) memory in a compressed format. Thus, when the graphics processor causes texture data to be fetched from the memory location where it is stored, the texture data must typically then be decompressed into a suitable (i.e. uncompressed) format for use by the graphics processor. It is not generally known in advance which texture data will be required by a given rendering process, and so the texture data should be, and generally is, compressed in such a manner that allows “random access” to the compressed texture data. This random access is typically achieved using block-based compression. Various texture compression algorithms are known in this regard that are designed for compressing texture data. For instance, one example of an efficient texture compression scheme is Arm's adaptive scalable texture compression (ASTC) technique, e.g. as described in U.S. Pat. No. 9,058,637 (Arm Limited), but various other compression schemes exist that can also suitably be used for compressing texture data including, but not limited to, Ericsson Texture Compression (ETC), PowerVR Texture Compression (PVRTC), S3 Texture Compression (S3TC), etc., and a graphics processor (graphics processing unit, GPU) may typically support one or more texture compression schemes.

The present Applicants however believe that there remains scope for improvements to the operation of a graphics processor (graphics processing unit, GPU) when generating a render output.

### BRIEF DESCRIPTION OF DRAWINGS

Various embodiments will now be described by way of example only and with reference to the following figures, in which:

FIG. 1 shows schematically an exemplary data processing system in which the technology described herein may be implemented;

FIG. 2 shows schematically an embodiment of a graphics processor including a texture mapping unit that interfaces with a texture cache system that is used to handle graphics processor texturing requests;

FIG. 3 shows the texture mapping unit of the graphics processing system of FIG. 2 in more detail;

FIG. 4 shows an example of graphics texture data;

FIG. 5 shows schematically texture filtering operations that may be performed by the texture mapping unit;

FIG. 6 shows an exemplary sequence of layers of neural network processing comprising an input layer and an output layer, between which are neural network layers comprising various convolutional layer (C-layer) layers and fully-connected layers (FC layer);

FIG. 7 illustrates a sequence of layers of neural network processing, wherein the output feature map from a layer of neural network processing may be written to a suitable buffer and then use as an input feature map for a next layer in the sequence, and wherein each layer of neural network processing may use processing parameters (e.g. such as weights) which are read from a suitable buffer;

FIG. 8 shows schematically training of a neural network to perform graphics texture compression according to an embodiment;

FIG. 9 shows an example of neural network based graphics texture decompression that may be performed according to an embodiment;

FIG. 10 shows schematically an example of a graphics processor (graphics processing unit, “GPU”) that may be used according to an embodiment;

FIG. 11 shows further details of the fragment thread creation process according to more traditional graphics processor operation;

FIG. 12 is a flow chart illustrate the rendering operation according to an embodiment;

FIG. 13 shows the fragment thread creation process according to an embodiment;

FIG. 14 shows an example of how a rendering pass may be performed according to more traditional graphics processor operation in which the rendering tile is processed according to scan line order;

FIG. 15 shows another example of how a rendering pass may be performed according to more traditional graphics processor operation in which the rendering tile is processed according to Morton (“Z”) order;

FIG. 16 shows an example tile to be rendered in which there are three primitives within that tile;

FIG. 17 shows the results of an initial processing pass according to the technology described herein in which a depth buffer and corresponding fragment visibility buffer are generated;

FIG. 18 shows how the fragment visibility information generated by the initial processing pass can be used to determine which graphics textures are visible at which sampling positions within the tile;

FIG. 19 shows a set of texture visibility information that can be generated by the initial processing pass;

FIG. 20 shows an example of how the order in which sampling positions can be controlled during the further processing pass; and

FIG. 21 shows example heuristics that may be used according to an embodiment to control the order in which sampling positions are processed.

Like numerals are used for like features in the drawings where appropriate.

### DETAILED DESCRIPTION

A first embodiment of the technology described herein comprises a method of operating a graphics processor to generate a render output, comprising:
for a sequence of primitives to be processed for the render output:
performing an initial processing pass comprising processing primitives within the sequence of primitives into respective sets of one or more fragments, each fragment associated with a respective set of one or more sampling positions within the render output, and then processing the resulting fragments to determine which particular primitives in the sequence of primitives are visible for which sampling positions within the render output; and
thereafter performing a further processing pass to generate respective output values for the respective sampling positions within the render output, the further processing pass comprising, for each sampling position for which an output value is to be generated, generating a respective output value for the sampling position by performing further processing of the particular primitive in the sequence of primitives that is visible at that sampling position,
wherein a set of information is generated from the processing of the sequence of primitives by the initial processing pass as to the further processing of primitives that is to be performed in respect of particular sampling positions within the render output when generating the respective output values for those particular sampling positions, and wherein the method further comprises:
controlling an order in which the sampling positions are processed during the further processing pass based on the set of information generated from the processing of the sequence of primitives by the initial processing pass.

A second embodiment of the technology described herein comprises a graphics processor that is operable to generate a render output, the graphics processor comprising:
a rendering circuit that is operable to process primitives into respective sets of one or more fragments, each fragment associated with a respective set of one or more sampling positions within the render output, and which rendering circuit is further operable to process the resulting fragments to generate respective output values for the respective sampling positions within the render output; and
a rendering control circuit that is configured to control the operation of the graphics processor to generate a render output, wherein:
for a sequence of primitives to be processed for a render output:
the rendering control circuit causes the graphics processor to process the sequence of primitives by, using the rendering circuit:
   performing an initial processing pass comprising processing primitives within the sequence of primitives into respective sets of one or more fragments, each fragment associated with a respective set of one or more sampling positions within the render output, and then processing the resulting fragments to determine which particular primitives in the sequence of primitives are visible for which sampling positions within the render output; and
   thereafter performing a further processing pass to generate respective output values for the respective sampling positions within the render output, the further processing pass comprising, for each sampling position for which an output value is to be generated, generating a respective output value for the sampling position by performing further processing of the particular primitive in the sequence of primitives that is visible at that sampling position, wherein the rendering control circuit is further configured to:
when the graphics processor is performing a further processing pass for a sequence of primitives for which a corresponding initial processing pass has already been performed, wherein a set of information is generated from the processing of the sequence of primitives by the initial processing pass as to the further processing of primitives that is to be performed in respect of particular sampling positions within the render output when generating the respective output values for those particular sampling positions:
control an order in which sampling positions are processed for the further processing pass based on the set of information generated from the processing of the sequence of primitives by the corresponding initial processing pass.

The technology described herein relates to graphics processing and graphics processors and in particular to graphics processors that, when generating a render output (e.g. frame), are operable and configured to effectively render primitives within a sequence of primitives that is to be processed for the render output (frame) in two separate processing passes.

For instance, as will be explained further below, the graphics processor according to the technology described herein, when processing a given sequence of primitives that is to be processed for a given render output, does so by first performing an “initial” processing pass in which primitives within the sequence of primitives are processed at least so far as to determine which primitives are (potentially) visible at which sampling positions within the render output, but wherein at least some of the final rendering operations that are to be performed to generate the respective (rendered) output values for the respective sampling positions within the render output including, e.g. applying any graphics texture data to those sampling positions, and writing out the (rendered) output values to storage, are deferred to a subsequent “further”processing pass.

In embodiments, therefore, the rendering process is performed by a rendering pipeline, in which a series of processing stages are performed, but the rendering pipeline is implemented by performing separate “initial” and “further” processing passes (with at least some of the later stages of the rendering pipeline effectively deferred to the further processing pass).

One or more primitives that were processed during an initial processing pass will thus be processed again during the corresponding, subsequent further processing pass, with the further processing pass performing suitable further processing of those primitives, as appropriate, e.g., and in particular, to ‘complete’ the rendering of those primitives and generate the desired (rendered) output values for the respective sampling positions at which those primitives are visible.

For example, according to the technology described herein, the initial processing pass generally comprises processing primitives into sets of one or more fragments, each fragment associated with one or more sampling positions within the render output (e.g. by rasterising the primitives), and then processing the resulting fragments to determine which fragments, and hence which primitives, are visible for which sampling positions within the render output.

The initial processing pass according to the technology described herein thus effectively determines which particular primitives in the sequence of primitives are visible at which sampling positions within the render output (or at least which primitives are visible based on the processing performed up to that point).

This fragment visibility determination during the initial processing pass may be done, for example, by depth testing the fragments against a suitable depth (Z) buffer that is also populated during the initial processing pass, e.g. in the normal manner for such depth (Z) testing.

As will be discussed further below, there may be further fragment processing stages during the initial processing pass after the (early) depth testing stage (such as late depth testing, etc., as desired). In embodiments, however, the fragment processing during the initial processing pass does not continue as far as to generate the ultimate (rendered) output values for the respective sampling positions within the render output, as the generation of the (rendered) output values is instead deferred to the corresponding further processing pass.

Accordingly, once such initial processing pass has been performed for a given sequence of primitives (i.e. there are no further primitives in the sequence of primitives to be processed, such that the initial processing pass for that sequence of primitives has finished), a corresponding further processing pass is then performed in respect of that same sequence of primitives, i.e. to complete the rendering process and generate the desired render output.

Thus, as mentioned above, the further processing pass according to the technology described herein generates the respective (rendered) output values for the respective sampling positions within the render output.

This is in embodiments done by processing the respective, different sampling positions in turn and generating a respective (rendered) output value for each sampling position being processed.

Thus, during the further processing pass, for a particular current sampling position that is being processed by the further processing pass, the processing that is performed in respect of that sampling position in embodiments comprises determining which particular primitive in the sequence of primitives is visible at that sampling position and then further processing that primitive in respect of that sampling position to generate a respective (rendered) output value for the sampling position.

In this respect, it will be appreciated that the determination of which particular primitive in the sequence of primitives is visible at a particular sampling position can be (and in embodiments is) done based on the results of the fragment visibility determination during the initial processing pass. For instance, as will be explained further below, the initial processing pass in embodiments generates a set of primitive identifying information indicating, for each sampling position within the render output, the particular primitive that is visible at that sampling position. This set of primitive identifying information can accordingly be used during the further processing pass to quickly identify which particular primitives are visible at which sampling positions.

Once it is determined which particular primitive in the sequence of primitives is visible at the particular current sampling position being processed, further processing of that primitive is then performed in respect of the current sampling position including, for example, converting the primitive into a respective fragment associated with the sampling position, and then performing suitable fragment processing operations to generate the respective (rendered) output value for the sampling position. As will be explained further below, these fragment processing operations may, e.g., and in embodiments do, include executing one or more fragment shader (program(s)) and then (in embodiments, as part of the fragment shader (program) execution) applying graphics texture data, as appropriate, to that sampling position to generate respective (rendered) output values, as well as writing out the respective (rendered) output value to storage.

The effect and benefit of rendering primitives in this manner, i.e. in two separate processing passes, as discussed above, is that the further processing pass can then be (and according to the technology described herein is) controlled based on the information gathered from the processing of the sequence of primitives during initial processing pass, e.g., to provide an improved, e.g., overall more efficient, graphics processor operation. That is, although performing two separate passes may mean that some additional processing overhead is introduced, the overall graphics processing operation may nonetheless be improved, as the information gathered from the initial processing pass operation can be used in various ways to control, and hence (try to) optimise the processing during the further processing pass.

In particular, according to the technology described herein, a set of information is generated from the processing of the sequence of primitives by the initial processing pass as to the further processing that is to be performed in respect of particular sampling positions within the render output to generate respective output values for those particular sampling positions, and this set of information is then used to control the order in which the sampling positions are processed during the further processing pass.

Thus, in embodiments, the technology described herein determines, based on the set of information generated from the processing of the sequence of primitives by the initial processing pass, an order in which the sampling positions within the render output should be processed during the further processing pass, and the further processing pass is then controlled accordingly so that the sampling positions within the render output are then processed according to this determined order (e.g. rather than there being a certain ‘set’, e.g. predetermined, order that is always used for such further processing passes, or the order for the further processing pass being determined in some other way).

In this way, by controlling the order in which sampling positions are processed during a further processing pass based on information generated by the corresponding initial processing pass, the order can then be, and in embodiments is, selected to improve, e.g., optimise, the further processing pass for a desired purpose, and hence in embodiments provide an overall improved rendering process.

For instance, the order in which sampling positions are processed during the further processing pass may generally be controlled in any suitable and desired manner and for any desired purpose.

In embodiments, however, the order in which sampling positions are processed during the further processing pass is particularly controlled to (try to) increase instances where the same data (structures) can be re-used between the processing of different sampling positions within the render output. In this way, it may be possible to reduce (memory) bandwidth associated with the overall rendering process. In this regard, the present Applicants recognise that the (final) fragment processing (rendering) operations to generate the respective (rendered) output values for the respective sampling positions may be relatively bandwidth intensive. The fetching of the relevant data (structures) from memory may also introduce processing ‘bubbles’ (latency) as the graphics processor may have to stall waiting for the data to be fetched. Increasing instances where the same data (structures) can be re-used between the processing of different sampling positions may thus also increase processing throughput. According to the technology described herein, therefore, at least some of the (final) fragment processing (rendering) operations are deferred to the further processing pass, as mentioned above, and the order in which the sampling positions are processed during the further processing pass is then controlled to (try to) increase instances where the same data (structures) can be re-used between the processing of different sampling positions within the render output (and hence to reduce (memory) bandwidth and/or increase processing throughput associated with these operations).

For instance, as mentioned above, the (final) fragment processing (rendering) operations that are performed in respect of a particular sampling position to generate the respective (rendered) output value for that sampling position (and which operations are according to the technology described herein deferred to the further processing pass) may, e.g., and typically do, include executing one or more fragment shader (program), and then applying graphics texture data to the sampling position in question, as appropriate.

To perform the required graphics texturing operations, the required graphics texture data may thus first need to be fetched in from memory (where the texture data is stored). As mentioned above, this fetching of data has an associated bandwidth cost. Additionally, processing may stall whilst the data is being fetched, thus also reducing processing throughput (or increasing latency).

Further, the graphics texture data is typically stored in memory in a compressed format, such that the graphics texture data may also need to be suitably decompressed for use by the graphics processor. In some embodiments, as will be explained further below, this texture decompression may be performed using neural network processing in which case there may be additional bandwidth costs associated with loading in the relevant neural network data structures for performing such neural network based texture processing (which neural network data structures may include the neural network model itself, as well as specific weights, biases, etc., for the particular execution of the neural network to perform the required texture processing). The bandwidth/latency cost associated with such neural network based texture processing can thus be relatively higher as different graphics textures may not only require different texture data to be fetched into the graphics processor but may also require different neural network data structures to be loaded in for processing that texture data.

In embodiments of the technology described herein, therefore, the order in which sampling positions are processed during the further processing pass is controlled based on the information generated by the processing of the sequence of primitives by the corresponding initial processing pass to (try to) reduce the overall (memory) bandwidth/latency cost associated with the rendering process, e.g., and in particular, to reduce the (memory) bandwidth/latency cost associated with the graphic texturing operations, e.g. as discussed above.

For instance, according to the technology described herein, the initial processing pass is operable and configured to determine which particular primitives in the sequence of primitives are (potentially) visible at which sampling positions.

Based on this, a set of information as to the further processing that is to be performed in respect of different sampling positions can thus be generated, which can in turn be used to identify multiple, different sampling positions within the render output for which the further processing that will be performed in respect thereof during the further processing pass (i.e. the further processing of the primitive(s) that are visible at those sampling positions) will use at least some of the same data structures. For example, in embodiments, this set of information generated as a result of the initial processing pass may be usable to identify which graphics textures are to be applied at which sampling positions.

The order in which the sampling positions are processed during the further processing pass can thus be (and in embodiments is) controlled accordingly to (try to) increase instances where some or all of the same data structures can be re-used for the further processing in respect of multiple, different sampling positions within the render output, e.g., and in embodiments, by processing those sampling positions that use the same data structures closer together, e.g. in consecutive order. This then in embodiments reduces instances where the same data has to be (and is) repeatedly fetched into the graphics processor (with that same data potentially being re-processed (decompressed) each time it is fetched into the graphics processor) during the further processing pass for multiple, different sampling positions. For instance, in embodiments where texture data is transferred via a texture cache (system), the technology described herein in embodiments increases the cache hit rate, and where the texture data is stored in the texture cache (system) in a decompressed format, this then means that the same texture data can be used multiple times without having to re-process (decompress) that texture data.

Thus, the set of information that is generated from the processing of the sequence of primitives by the initial processing pass may be, and in embodiments is, usable to identify multiple, different sampling positions for which the same (or at least similar) graphics texture data is to be applied. The further processing pass can accordingly then be controlled to process those sampling positions closer together, e.g., and in embodiments, such that once the required data for processing a particular graphics texture has been loaded in to suitable (local) storage associated with the graphics processor (whether that data be the graphics texture data itself, or one or more neural network data structures for processing that graphics texture), the order in which the sampling positions are processed is then controlled such that the data can then be (and is) re-used for the processing of multiple, different sampling positions (i.e. without having to invalidate that data to fetch in data associated with a different graphics texture in between the processing of those multiple, different sampling positions).

The effect of this is therefore to increase instances where some or all of the same data can be re-used for the processing of multiple sampling positions, hence in embodiments reducing (memory) bandwidth and/or processing latency by avoiding having to repeatedly re-fetch (and potentially re-process) the same data.

For instance, in a typical render output being generated, there may be multiple sampling positions within the render output for which the same graphics texture data is to be applied. However, it is not generally known in advance which graphics texture data will be applied at which sampling positions (as this is generally only determined during the rendering process, i.e. based on the (final) determination of which primitives are visible at which sampling positions).

Thus, in a simpler approach, the order in which sampling positions are processed during the further processing pass could always be a certain ‘set’, e.g. selected, order, which could, e.g., correspond to a raster order (but could in general be any suitable and desired processing order, and so could also correspond to a Morton (or “Z”) order, for example). This same ‘set’ order may then always be used for each instance of the further processing pass (i.e. for each sequence of primitives/render output that is to be processed in this way). Using a consistent order of processing may itself have certain benefits.

However, if the sampling positions were always simply processed during the further processing pass according to raster order, or indeed any particular ‘set’ processing order, this order may not be (and typically will not be) the optimal order for increasing instances where some or all of the same data structures can be re-used for the further processing in respect of multiple, different sampling positions within the render output, for instance. In the worst-case scenario, when using a particular set processing order, the graphics processor could end up cycling repeatedly between loading in the same alternate sets of graphics texture data, with significant (memory) bandwidth cost and significantly reduced processing throughput.

Thus, according to the technology described herein, the order in which sampling positions are processed during the further processing pass can be (and is) determined at run-time, as part of the rendering process, so that there is no particular ‘set’ or fixed processing order that is always used for the further processing pass, but instead a suitable processing order is determined based on the information generated by the initial processing pass (i.e. since at that point it can be determined which graphics textures are to be applied for which sampling positions and this information can then be used to control the order for the subsequent further processing pass).

At least in embodiments, therefore, the technology described herein thus tries to identify sampling positions for which it can be determined (i.e. based on the information generated by the initial processing pass) that some or all the same data or data structures will be used for the further processing during the further processing pass, and then controls the order in which the sampling positions are processed during the subsequent further processing pass accordingly to try to process at least some of those sampling positions relatively closer together, e.g. in consecutive order.

This then means that once the relevant data or data structures are loaded into the graphics processor, they can then be (and in embodiments are) re-used for the processing of multiple sampling positions, and in embodiments for all sampling positions for which the processing thereof will use those data (structures), before that data is invalidated (thus in embodiments saving having to potentially load the same data or data structures into the graphics processor multiple times during the further processing pass, and hence reducing (memory) bandwidth associated with the overall rendering process).

The technology described herein thus allows the order in which sampling positions are processed during the further processing pass to be optimised for some particular purpose based on the results of the initial processing pass, and in this way in embodiments improves the overall rendering process. As mentioned above, the further processing pass is in embodiments optimised for reducing (memory) bandwidth and/or processing latency associated with the graphics texturing operations. However, it will be appreciated that the technology described herein may also advantageously be used to optimise the further processing pass for some other purpose. Thus, whilst various embodiments are described above in relation to reducing (memory) bandwidth and/or processing latency associated with the graphics texturing operations it will be appreciated that similar considerations may also apply to other ones of the fragment processing operations that are deferred to the further processing pass. For instance, there may be various data structures that need to be loaded into the graphics processor for the fragment shader (program) execution, and the order in which sampling positions are processed during the further processing pass could therefore alternatively, or additionally, be controlled to (try to) increase instances where the same fragment shader (program) data is re-used between multiple, different sampling positions. Various other examples would be possible in this regard.

The technology described herein may therefore provide various benefits compared to other possible approaches.

Subject to the particular requirements of the technology described herein, the rendering process that is performed for a sequence of primitives may be performed in any suitable and desired manner.

For example, as mentioned above, the initial processing pass is performed to determine which particular primitives in the sequence of primitives are visible for which sampling positions within the render output.

In embodiments, the initial processing pass thus generates a set of “visibility” information that is usable to identify which primitives are visible at which sampling positions, and hence is usable to determine the further processing to be performed in respect of those sampling positions (which knowledge can then be (and is) used to appropriately control the order in which the sampling positions are processed during the further processing pass, e.g. as described above).

The initial processing pass may thus comprise any suitable and desired steps to do this. In general, however, the initial processing pass comprises processing (e.g. rasterising) primitives into respective sets of one or more fragments and then performing one or more fragment processing operations to determine the desired visibility information. The visibility information is typically, and in embodiments, based on the fragment depth values. That is, which fragment will be visible at a particular sampling position will typically be, and is in embodiments, determined (at least in part) by which fragment is front-most in the scene (i.e. has the closest depth value).

The initial processing pass thus in embodiments comprises (early) depth testing the fragments to update a depth buffer for the render output. The depth buffer stores a set of per-sampling position depth values for the render output. Thus, in embodiments, the initial processing pass comprises testing a (the current) fragment's depth value against a corresponding depth value stored in a depth (Z) buffer. If the fragment survives the depth testing, the depth buffer is in embodiments then updated to include the current fragment's depth value, and so on, until all of the fragments for the primitives have been processed. The resulting depth buffer at the end of the initial processing pass therefore represents the depth buffer for the sequence of primitives as a whole.

In some embodiments the initial processing pass thus comprises processing (e.g. rasterising) the primitives into respective sets of one or more fragments and then depth testing the fragments to update a depth buffer. The depth buffer is in embodiments used to generate a set of primitive identifying information, as will be explained further below, which set of primitive identifying information is written to suitable storage at the end of the initial processing pass.

The set of primitive identifying information could be written out to external memory but in embodiments the set of primitive identifying information is written to local storage, e.g. a dedicated portion of RAM that has been allocated for the current rendering operation (e.g. for a tile that is being rendered), and which local storage can thus be overwritten once the current rendering operation is complete. For example, in a tile-based rendering system, the dedicated portion of RAM may be a (portion of a) tile buffer. Various arrangements would however be possible in this regard.

In some embodiments the fragment processing for the initial processing pass finishes at this point, i.e. after writing out the set of primitive identifying information (and any other buffers that may desirably be written out). Thus, in embodiments, after the (early) depth testing is performed, and the depth buffer updated accordingly (as needed), the fragment processing for the initial processing pass is finished, and the fragments are not processed further by the initial processing pass (although the initial processing pass may continue, e.g., to populate the set of primitive identifying information, before the initial processing pass itself is complete).

Thus, in some embodiments, the initial processing pass does not, e.g., execute a fragment shader to render the fragments (e.g. to determine colour values for the final render output). In other embodiments a (partial) fragment shader may however be executed. For example, this may be appropriate to handle primitives where a fragment shader is needed to determine the fragment's depth value and/or coverage. In that case, final (colour) output is in embodiments still disabled and fragment shader is run far enough to update depth buffer, but the fragments are in embodiments not rendered in full to avoid having to calculate the final rendered output data at this stage (since it may be overwritten later). Various arrangements would be possible in this regard.

After the initial processing pass is finished, e.g., and a suitable set of visibility information has been determined, a corresponding further processing pass is performed to generate the final render output. The result of the further processing pass is thus to generate the final render output, e.g. by performing fragment shading to generate a set of rendered output values for the respective sampling positions within the render output (e.g. to determine the appearance (e.g. colour) that the associated sampling positions should have in the final render output).

The processing that is performed during the further processing pass in respect of a particular sampling position may thus, and in embodiments does, comprise determining which particular primitive in the sequence of primitives is visible at that sampling position, converting the primitive into a respective fragment associated with that sampling position, and then performing one or more further fragment processing operations including, e.g., executing a fragment shader and applying appropriate graphics texture data in order to determine the corresponding (rendered) output value for that sampling position.

As mentioned above, according to the technology described herein, the order in which sampling positions are processed during the further processing pass is controlled based on information generated by the initial processing pass.

The processing that is performed during the further process pass is thus in embodiments performed on a per-sampling position basis. Thus, the further processing pass in embodiments selects a first sampling position for which a (rendered) output value is to be generated, and then performs suitable processing in respect of that first sampling position to generate a respective (rendered) output value. The further processing pass in embodiments then proceeds by selecting a next (second) sampling position to be processed, and so on.

In embodiments, therefore, once the particular current sampling position has been processed, i.e. its respective (rendered) output value has been generated, the further processing pass then proceeds to process a ‘next’ sampling position in a similar fashion, and so on for further next sampling positions, with the further processing pass processing the respective (next) sampling positions in turn until all of the sampling positions for which (rendered) output values are to be generated have been appropriately processed to generate the desired overall set of (rendered) output values for the render output in question.

The initial processing pass could similarly also be performed on a per-sampling position basis. In that case, the order in which the sampling positions are processed during the initial processing pass may be a certain ‘set’, e.g. predetermined, order, such as raster order (and the order may therefore, and typically will, change between the initial processing pass and the corresponding further processing pass). However, given that the initial processing pass needs to process all of the primitives in the sequence of primitives for all sampling positions in order to determine the “visibility” information, it may be more efficient to perform the initial processing pass on a per-primitive basis, and so the initial processing pass in embodiments processes the primitives in the sequence of primitives in turn. Thus, for each primitive in the sequence of primitives, the initial processing pass in embodiments rasterises that primitive into its set of fragments (i.e. by iterating over the sampling positions and determining the primitive coverage at those sampling positions, e.g. in the normal manner for rasterisation), and any resulting fragments associated with the primitive are then processed to determine the “visibility” information. (In that case, the order in which sampling positions are processed during the initial processing pass will effectively be determined by the primitive coverage (and the order in which the primitives occur in the sequence of primitives) (and so this order may similarly not be optimised for any particular purpose, e.g. for reducing (memory) bandwidth, since the primitives may be included in the sequence of primitives in any order, and there is no requirement that primitives that use the same graphics texture are adjacent in the sequence of primitives, for example).)

Thus, in some embodiments, the initial processing pass is performed on a per-primitive basis (e.g. by determining which primitives need to be processed for the render output (region) in question and then processing those accordingly), whereas the further processing pass is performed on a per-sampling position basis, with the order in which sampling positions are processed being controlled in the manner described above.

Various other arrangements would however be possible in this regard.

For example, the further processing pass could also be performed on a per-primitive basis, and in that case the order in which sampling positions are processed may be controlled by re-ordering the primitives within the sequence of primitives so that the order in which primitives are processed during the further processing pass may be (and typically will be) different to the order in which primitives are processed during the initial processing pass. In this case, in embodiments only the visible portions of the primitives are processed during the further processing pass.

Thus, in general, one or more of the same primitives may be (and in embodiments are) processed in both processing passes, but the same primitive(s) undergo different processing in the respective processing passes. For example, in embodiments, the initial processing pass involves at least processing (e.g. rasterising) the primitives into fragments and performing fragment depth testing to generate a set of “visibility” information for the sequence of primitives. The initial processing pass does not however write out, and in embodiments does not generate either, any final rendered output (e.g. colour) values. This is then done by the further processing pass which generates the respective (rendered) output values for the respective sampling positions within the render output being generated.

Thus, the further processing pass, for each sampling position for which an output value is to be generated, in embodiments generates the respective (rendered) output value by determining the particular primitive that is visible at that sampling position, and then rendering the primitive for that sampling position, e.g., including executing any fragment shader(s) and applying graphics texture data, as appropriate, to generate and output the desired (e.g. colour) value for that sampling position.

The determining during the further processing pass which particular primitive in the sequence of primitives is visible at a particular sampling position is in embodiments done using the information generated by the initial processing pass. For example, as will be explained further below, the initial processing pass in embodiments generates a set of primitive identifying information indicating which particular primitive is visible for each sampling position within the render output. This information can therefore be used to quickly identify during the further processing pass which particular primitives need to be processed for which sampling positions. For example, for each sampling position, the sequence of primitives can be quickly iterated over to identify which primitive matches the corresponding entry in the set of primitive identifying information. Various arrangements would however be possible in this regard.

It will be appreciated that the processing that is performed in either the initial processing pass or further processing pass may in general also comprise any other suitable processing steps (stages) that may be desired.

As mentioned above, the initial processing pass in embodiments generates a set of “visibility” information for the sequence of primitives. The set of “visibility” information that is generated from the processing of primitives by the initial processing pass according to the technology described herein may generally take any suitable and desired form.

In an embodiment, however, as alluded to above, the initial processing pass generates a set of “primitive identifying” information that stores—for respective sampling positions within the render output—respective primitive identifiers identifying which particular primitives in the sequence of primitives should be processed further for which sampling positions within the render output. The primitive identifier that is stored for a respective sampling position thus indicates the particular primitive in the sequence of primitives that is visible at that sampling position, and hence which should be subsequently be processed further for the sampling position to generate the respective (rendered) output value. In embodiments, a single primitive is identified to be processed further for a (and each) respective sampling position (and in some cases the set of primitive identifying information is configured to only be able to identify a single primitive). In some embodiments, multiple primitives may be identified to be processed further for a (and each) respective sampling position, and the set of primitive identifying information can be configured appropriately to facilitate this. For example, if the sequence of primitives includes non-opaque primitives, and a non-opaque primitive is the foremost primitive for a particular sampling position, it may be appropriate to store multiple (partially visible) primitives in respect of that sampling position, optionally also with an indication that alpha blending is to be performed. Various arrangements would be possible in this regard.

The initial processing pass thus in embodiments generates a set of primitive identifying information that indicates, by reference to the stored primitive identifiers, which primitives are visible at which sampling positions (and hence which primitives should subsequently be processed further for which of the sampling positions).

The set of primitive identifying information thus in embodiments contains a plurality of entries corresponding to the sampling positions within the render output and which entries are able to store for the respective sampling positions within the render output a respective primitive identifier indicating which primitive (if any) should be further processed for the corresponding sample point(s).

Any suitable primitive identifiers can be used in this respect so long as different primitives in the sequence of primitives can suitably be identified. There may also be a suitable ‘null’ identifier that can be used to indicate that nothing is visible at a particular sampling position (and hence further processing of that sampling position can be effectively skipped). Various arrangements would be possible in this regard.

There may in general be any suitable and desired correspondence between the entries in the set of primitive identifying information and the sampling positions within the render output. For example, the set of primitive identifying information should be (and in embodiments is) able to store a primitive identifier in respect of each sampling position within the render output. That is, the set of primitive identifying information in embodiments stores for each sampling position within the render output a respective primitive identifier indicating the primitive (if any) that should be processed for that sampling position.

Thus, in some embodiments, there may be a direct one-to-one correspondence between the number of entries in the set of primitive identifying information and the number of sampling positions within the render output, such that each sampling position has a corresponding (unique) entry in the set of primitive identifying information for storing a respective primitive identifier for that particular sampling position.

However, it would also be possible to arrange the set of primitive identifying information in a “hierarchical” manner, for example, such that the set of primitive identifying information (also) comprises entries corresponding to groups of plural sampling positions within the render output, and in some embodiments this is done. In that case, the set of primitive identifying information may typically contain a greater number of entries than there are sampling positions, e.g., and in embodiments, such that the set of primitive identifying information contains respective entries for each individual sampling position, but also contains one or more entries that apply to groups of sampling positions, e.g., and in embodiments, based on a hierarchical division of the render output.

For example, in addition to the entries corresponding to individual sampling positions, there may also be entries corresponding to groups (or “patches”) of, e.g., 4, 16, 32, 64, etc., sampling positions. Further, an entry may be provided corresponding to the entire render output.

Various arrangements would be possible in this regard.

The set of primitive identifying information thus indicates which primitives are visible at which sampling positions.

The particular control of the order in which sampling positions are processed during the further processing pass could in some embodiments be performed using the set of primitive identifying information. For example, it can be identified (directly) from the set of primitive identifying information which primitives are visible at which sampling positions, and the control may thus be performed to process any sampling positions for which the same primitive is visible closer together, e.g. consecutively. This will then help reduce bandwidth since the same primitives will generally require the same data (structures) to be used. It may also be possible to identify (other) primitives that also use some or all of the same data (structures), e.g. where it is known that certain primitives share data (structures).

The present Applicants however recognise that in a typical render output there may be multiple, different primitives that use some or all of the same data structures. Thus, in embodiments, rather than simply using the set of primitive identifying information itself to control the further processing pass, the set of primitive identifying information is processed to determine further information as to the particular further processing that is to be performed in respect of the different sampling positions during the further processing pass, and the control of the further processing pass is then performed based on that information.

For instance, as alluded to above, in embodiments, the order in which the sampling positions are processed during the further processing pass is controlled to (try to) reduce (memory) bandwidth associated with graphics texturing operations performed during the further processing pass.

It will be appreciated in that regard that a particular primitive (vertex) will typically have defined for it a respective graphics texture that may be applied to sampling positions where that primitive is visible. Further, that same graphics texture may also be associated with other primitives in the sequence of primitives. Thus, from the set of primitive identifying information generated by the initial processing pass, it can accordingly be identified which graphics textures are to be applied at which sampling positions within the render output, and the processing order for the further processing pass may thus be, and in embodiments is, controlled on that basis.

In embodiments, therefore, the set of primitive identifying information generated from the initial processing pass is further processed to determine a corresponding set of “texture identifying” information indicating which graphics textures are to be applied at which sampling positions within the render output. This may be beneficial since the texture identifying information directly indicates which graphics textures are to be applied at which sampling positions and so when the control is performed to try to reduce texturing bandwidth, this may facilitate a simpler control operation.

The respective entries of the set of “texture identifying” information thus generally indicate, for respective sampling positions, which graphics texture is to be applied when processing that sampling position. This can be done in various suitable ways as desired.

For example, in some embodiments, the respective entries of the set of “texture identifying” information may store texture identifiers per se (i.e. that directly indicate a graphics texture that is to be applied at the respective sampling position). Other arrangements would however be possible. For example, respective entries of the set of “texture identifying” information could also or alternatively identify a class of textures that can be processed using the same neural network data structures, for instance.

As another example, the shader program (e.g. pointer) could be used as an identifier of the graphics texture that is to be applied. For instance, a shader program may be compiled with the texture (identifier) hardcoded into the shader program, and in that case the shader program identifier also serves as texture identifying information.

Various arrangements would be possible in this regard.

Subject to the particularly requirements of the technology described herein, this set of “texture identifying” information can generally be arranged and stored in any suitable fashion, including hierarchical arrangements, e.g. similarly to the set of primitive identifying information.

Various arrangements would be possible in this regard.

In embodiments, therefore, the set of primitive identifying information generated from the initial processing pass is iterated over to generate a corresponding set of texture identifying information.

Other arrangements would however be possible.

For example, it would also be possible for the initial processing pass to directly generate a set of texture identifying information (i.e. rather than adding primitive identifiers to a set of primitive identifying information that is populated during the first, pre-pass operation, and then potentially iterating over the set of primitive identifying information to generate a set of texture identifying information, the initial processing pass could directly populate a set of texture identifying information). Thus, a benefit of generating and storing the set of primitive identifying information is that this may also be used during the further processing pass (e.g. to accelerate determining which primitives are visible at which sampling positions). It is also relatively straightforward to then generate the texture identifying information from such primitive identifying information. However, the particular control of the technology described herein may not necessarily use the set of primitive identifying information, and could in principle be performed using only the set of texture identifying information, and so in some cases it may be desired to generate this directly.

In whatever manner it is generated, in embodiments, the order in which sampling positions are processed during the corresponding further processing pass may then be controlled based on such set of texture identifying information.

In embodiments, therefore, the processing of the set of primitive identifying information generated from the initial processing pass to generate the set of texture identifying information (when this is done) is performed prior to performing the corresponding further processing pass.

The processing that is done in advance of the further processing pass, e.g., to generate the set of texture identifying information, may further comprise processing the set of texture identifying information to determine an overall optimal processing order for the further processing pass before starting the further processing pass. That is, after the initial processing pass has finished (i.e. after all of the primitives in the sequence of primitives have been processed by the initial processing pass, as necessary), there may be one or more post-processing steps that are performed prior to performing the corresponding further processing pass and these post-processing steps may include a step of determining a desired processing order for the further processing pass.

Other arrangements would however be possible.

For example, in some embodiments, the control of the processing order is performed dynamically during the further processing pass.

Thus, the further processing pass may start at a particular sampling position and the control that is performed may be to select a suitable next sampling position to process after that particular sampling position, and so on, with the selection of the next sampling position to be processed being performed based on the visibility information generated during the initial processing pass (in whatever particular form that takes).

Various arrangements would be possible in this regard.

As mentioned above, in embodiments, the processing order for the further processing pass is in embodiments controlled to try to increase instances where data that is to be used for such graphics texturing operations can be re-used for the processing of different sampling positions. This is in embodiments done by identifying (groups of) sampling positions that may use some or all of the same data (structures), and then controlling the processing order such that the identified (groups of) sampling positions are processed relatively closer together, e.g. consecutively, such that the processing can re-use the same data (structures).

For example, when it is identified that the same graphics texture is to be applied at multiple, different sampling positions within the render output, those sampling positions are in embodiments then processed closer together, e.g., in embodiments as a consecutive set of sampling positions. This then means that the data for that same graphics texture may only need to be fetched into the graphics processor once, as the same data can then be re-used for each of the different sampling positions that require that data, without having to fetch in any other data in the meantime (that could cause that data to be invalidated) (in contrast, if the multiple, different sampling positions requiring the same data were not processed closer together, that same data would potentially need to be fetched and re-fetched for each of the different sampling positions). Determining an order in which sampling positions are to be processed for the further processing pass may thus be done by, for a particular current sampling position (i.e. the current sampling position being considered as part of the order determination), selecting a next sampling position to be processed based on identifying that the graphics texture data that is to be applied at that next sampling position is the same graphics texture data to be applied at the current sampling position.

Thus, in embodiments, controlling an order in which the sampling positions are processed during the further processing pass comprises identifying a group of sampling positions for which the same graphics texture data is to be applied, and processing the sampling positions in the identified group of sampling positions in consecutive order

As another example, when neural network based texture processing is being used, when it is identified that some or all of the same neural network data structures can be used for processing (decompressing) graphics texture for multiple, different sampling positions, those sampling positions are in embodiments then also processed closer together, such that those same neural network data structures can then be, and in embodiments are, re-used for each of the different sampling positions.

Thus, in embodiments, the graphics processor supports neural network based texture processing in which when graphics texture data is loaded into the graphics processor during the further processing pass, the graphics texture data is processed into a format for use by the graphics processor by one or more neural networks, the one or more neural networks having an associated set of neural network data structures. For example, as discussed above, the graphics texture data is in embodiments loaded into the graphics processor in compressed form, and the processing of the (compressed) graphics texture data thus in embodiments comprises decompressing the graphics texture data into a suitable uncompressed format for use by the graphics processor.

In that case, determining an order in which sampling positions are to be processed for the further processing pass may be done by, for a particular current sampling position (i.e. the current sampling position being considered as part of the order determination), selecting a next sampling position to be processed based on identifying that the next sampling position uses some or all of the same neural network data structures as the current sampling position. For example, this may involve identifying a next sampling position that uses the same neural network. However, in general, especially when different neural networks are trained using transfer learning, different neural networks may share at least some data or data structures (e.g. when transfer learning is used to generate different neural networks, at least some layers of the different neural networks may use a portion of the same data or data structures). Thus, this may involve identifying a next sampling position that uses some of the same data or data structures as the current sampling position, and this still provides a benefit (e.g. compared to fetching in an entirely new set of data or data structures for the new neural network).

Thus, in embodiments, controlling an order in which the sampling positions are processed during the further processing pass comprises identifying a group of sampling positions for which some or all of the same neural network data or data structures are to be used, and processing the sampling positions in the identified group of sampling positions in consecutive order.

In embodiments, these heuristics are applied cumulatively to determine an overall order in which sampling positions should be processed. For instance, and in embodiments, the control of the processing order for the further processing pass is performed such that any sampling positions that require the same graphics textures are first identified, and these sampling positions are then processed closer together, e.g. consecutively. Once all of the sampling positions that require the same graphics textures have been processed, a set of further sampling positions that may not necessarily require the same graphics texture but that nonetheless use some or all of the same data or data structures is then identified, such that the processing can then move on to processing that set of further sampling positions. This can then continue appropriately until all sampling positions have been processed.

Various other suitable heuristics may be used in this regard, and this control can be done in a more or less complex manner, as desired.

In this respect, as mentioned above, it will be appreciated that the control of the processing order that is performed for the further processing pass may generally be performed for any suitable and desired purpose.

Thus, whilst various embodiments are described above in the context of controlling the processing order for the further processing pass based on a set of texture identifying information, the control of the processing order that is performed for the further processing pass may generally be performed for other purposes, and based on other suitable information generated by the initial processing pass, as desired. For instance, the further processing pass may, and in embodiments does, also include executing in respect of each sampling position for which an output value is being generated, one or more fragment shader (program), and there may also be bandwidth costs associated with loading in (data for) such fragment shader (program). Thus, the control of the processing order that is performed for the further processing pass may also, or alternatively, be performed to try to reduce (memory) bandwidth associated with fragment shader (program) execution (with or without considering graphics texturing operations that may be performed as part of the fragment shader (program) execution).

In that case, rather than, or in addition to, processing the set of primitive identifying information to generate a corresponding set of texture identifying information, the set of primitive identifying information may be processed to generate a set of fragment shader (program) identifying information identifying which fragment shader (program) is to be executed for which sampling positions within the render output. This can then be used in a similar manner described above to determine a desired processing order for the further processing pass.

For instance, when determining an order in which sampling positions are to be processed for the second, main pass operation, for a particular sampling position, the next sampling position to be processed may be selected based on the next sampling position requiring the same fragment shader (program) to be executed as the current (previous) sampling position.

Thus, in embodiments, controlling an order in which the sampling positions are processed during the further processing pass comprises identifying a group of sampling positions for which the same fragment shader is to be executed, and processing the sampling positions in the identified group of sampling positions in consecutive order.

In embodiments, various combinations of these heuristics may be used when determining the processing order. Thus, when determining an order in which sampling positions are to be processed for the further processing pass, for a particular current sampling position, the next sampling position to be processed may be selected based on any one or more of:
(i) the same primitive being visible at the next sampling position as is visible at the current sampling position;
(ii) the next sampling position requiring the same graphics texture data as the current sampling position;
(iii) the next sampling position requiring some or all of the same (neural network) data structures as the current sampling position; and
(iv) the next sampling position requiring the same fragment shader (program) to be executed as the current sampling position.

In embodiments, some or all of these heuristics may be applied cumulatively, e.g. by first attempting to identify any potential next sampling positions for which the same primitive is visible and/or for which the same graphics texture data is to be applied, and then, if there are no suitable next sampling position candidates that can be identified on this basis, then attempting to identify any potential next sampling positions that do not necessarily relate to the exact same graphics texture but for which the same data structures can be used, or at least some of the same data structures, etc.

Various examples would be possible in this regard and a benefit of the technology described herein is that the further processing pass can be controlled, and hence optimised, based on the information gathered by the initial processing pass in any suitable manner, as desired.

It will be appreciated that when determining the next sampling position to be processed, there may be multiple suitable candidates for the next sampling position. The determination of the order in which sampling positions should be processed may therefore also use other suitable heuristics, as desired, when determining the order in which sampling positions are to be processed. For example, the first suitable candidate next sampling position that is identified could be selected as the next sampling position. However, it would also be possible to apply other criteria to prioritise which sampling positions are visited first.

For example, if there are multiple suitable candidates for the next sampling position (e.g. multiple sampling positions at which the same (graphics texture, neural network, etc.) data is to be applied), these candidates could be processed according to scan line order (e.g. raster scan line for an immediate mode rendering system, or tile scan line for a tile-based rendering system). In embodiments, however, the processing order is controlled to (try to) maximise spatial locality, and so when there are multiple suitable candidates for the next sampling position, these may be processed according to a space-filling curve (such as Morton (or “Z”) or Hilbert order), for example. Since the order in which sampling positions are processed during the further processing pass is controllable (and so is not generally known in advance but is instead determined at run-time, e.g., and in particular, based on the information generated by the corresponding initial processing pass), a further mechanism may be required to track which sampling positions have been processed. Thus, in embodiments it is tracked during the further processing pass which sampling positions have been processed. This tracking can be done in various suitable ways as desired. For example, in embodiments, a suitable scoreboarding mechanism may be used.

According to the technology described herein, therefore, an order in which sampling positions are processed for the second, main pass operation is controlled based on the set of visibility information generated from processing of primitives by the first, pre-pass operation. This control can be performed for any suitable purpose but in embodiments is done to (try to) reduce bandwidth associated with the fragment processing (rendering) operations performed during the second, main pass operation, e.g. as described above.

It will be appreciated that the set of visibility information generated from processing of primitives by the initial processing pass may also be suitably used to perform other control operations for the corresponding further processing pass, as desired. For example, the set of visibility information generated from processing of primitives by the initial processing pass may also be used to control a ‘quality level’ at which the graphics texture data is applied to one or more sampling positions within the render output. Thus, if a particular graphics texture is only visible at a relatively smaller number of sampling positions, or that texture is only visible in peripheral regions, it may be acceptable to reduce the quality level at which that graphics texture is applied since any reduction in quality is unlikely to be perceptible to the user. Various arrangements would be possible in this regard.

Subject to the particular requirements of the technology described herein, the graphics processor may be any suitable graphics processor.

In some embodiments, the graphics processor may be operable and configured to perform immediate mode rendering. In that case, the initial and further processing passes of the technology described herein may be performed as part of the immediate mode rendering operations.

In other embodiments the graphics processor is operable and configured to perform tile-based rendering. The graphics processor may therefore have any suitable and desired processing stages and/or elements that a graphics processor may have when performing tile-based rendering.

When processing a render output in such tile-based rendering systems, an initial geometry processing (sorting) operation is performed in order to sort the geometry, which is defined in terms of a set of primitives to be processed for the render output, relative to the rendering tiles into which the render output is subdivided for rendering. The actual rendering of the tiles is then performed in a subsequent rendering operation, with the tiles in embodiments being rendered separately, e.g. one after another.

In a tile-based rendering system, the initial and further processing passes of the technology described herein may thus be performed as part of the tile rendering operations that are performed in respect of a (and each) tile, e.g., and in embodiments, in response to the graphics processor receiving a command to render a tile. That is, the initial and further processing passes are in embodiments performed within a rendering tile. The sequence of primitives that are processed in the manner described above therefore in embodiments corresponds to a sequence of primitives to be rendered for a respective rendering tile (e.g. as identified using one or more primitive lists associated with that tile that have been generated during tiling operations).

The graphics processor of the technology described herein thus in embodiments comprises a geometry processing (sorting) circuit and a rendering circuit.

For example, in some embodiments, the geometry processing (sorting) operation comprises a ‘tiling’ operation that is performed to generate a set of primitive lists indicative of the distribution of the primitives relative to the tiles that can be used to identify which primitives are to be rendered for which tiles. This can be done in any suitable manner, e.g. in the normal way for generating primitive lists, and the primitive lists may be prepared for any suitable regions of the render output. Thus, there may or may not be a one-to-one correspondence between the primitive lists and the actual rendering tiles.

In that case, once all of the geometry has been processed, the primitive lists are in embodiments then written out, e.g. to external (e.g. main) memory.

The primitive lists are then used during a subsequent rendering process (state) in order to perform the actual rendering of the individual tiles. The rendering circuit of the graphics processor thus in embodiments comprises a primitive list reading circuit that is configured to, when a tile is issued for rendering, identify using the respective primitive list or lists applying to the tile in question a sequence of primitives that should be processed for the tile.

The primitive list reading circuit is thus in embodiments configured to obtain the primitive lists, e.g. from memory, identify a sequence of primitives that should be processed for the tile and issue the identified primitives for rendering. This may be done in any suitable and desired manner, e.g. depending on the format of the primitive lists. For example, where the primitive lists apply to hierarchically arranged regions of the render output (such that there is not necessarily a one-to-one correspondence between primitive lists and tiles to be rendered and such that a given tile may be associated with multiple primitive lists) the step of identifying the sequence of primitives may comprise processing multiple primitive lists and merging primitives from the multiple primitive lists into the desired rendering order.

Other geometry processing (sorting) operations could however be performed. For example, in other embodiments, the geometry processing (sorting) operation may comprise generating a hierarchy of ‘bounding boxes’ that is indicative distribution of the primitives relative to the tiles and that can be used to identify which primitives are to be rendered for which tiles. In that case, the geometry processing (sorting) operation may comprise generating and writing out such bounding box hierarchy, and the subsequent rendering process may then use this to perform the actual rendering of the individual tiles.

Various other arrangements would be possible in this regard.

(Thus, when processing a particular tile, the initial processing pass in embodiments (only) processes primitives that fall within that tile, and in embodiments only processes the parts (fragments) of those primitives that fall within that tile.)

The identifying of a particular sequence of primitives to be rendered (e.g. the sequence of primitives for a particular tile) is in embodiments performed in response to a command to render a tile. The identified primitives are then issued accordingly into a rendering pipeline for further processing, which rendering pipeline includes the initial and further processing passes, as described above. In some embodiments however the sequences of primitives may be identified in advance (and, e.g., pre-fetched) of the graphics processor executing the rendering command that triggers the rendering process of the technology described herein. Various arrangements would be possible in this regard.

The technology described herein relates particularly to the rendering operations that are performed on the primitives that are identified to be processed. The rendering is in embodiments performed in a pipelined manner as a series of processing stages but with the pipeline being implemented across the two separate processing passes. Subject to the requirements of the technology described herein the rendering pipeline may in general comprise any suitable and desired processing stages that a graphics processing (rendering) pipeline may contain.

In particular the rendering according to the technology described herein in embodiments uses a rasterisation-based approach.

The rendering circuit (pipeline) of the graphics processor of the technology described herein thus generally includes a rasteriser for processing primitives into respective sets of fragments and a renderer that is configured to process (render) the resulting fragments to determine the appearance (e.g. colour) that corresponding sampling positions should have in the final render output.

The rasteriser (rasteriser circuit) can be configured to operate in any suitable and desired manner, for example as in known rasterising arrangements. It should operate to generate graphics fragments for processing in dependence upon which sampling positions (or which sets of sampling positions) of an array of sampling positions covering the area of the render output, a given primitive, etc., received by the rasteriser covers (at least in part).

The rasteriser in an embodiment is operable to generate a graphics fragment for each sampling position covered by, and/or for each set of plural sampling positions (e.g., sampling mask) found to include a sampling position that is covered by, the (and each) primitive being rasterised (and that is not otherwise culled from processing for another reason, such as by the primitive failing an early depth test). Correspondingly, each fragment generated by the rasteriser may represent (have associated with it) a single sampling position, or plural sampling positions, as desired. In an embodiment, each fragment represents a set of plural, in an embodiment a set of four (and in an embodiment a 2×2 array of), sampling positions.

The renderer (fragment processing circuit) of the graphics processor should be operable to render (shade) graphics fragments it receives to generate the desired output graphics fragment data. It may contain any suitable and desired rendering elements and may be configured in any suitable and desired manner. Thus, for example, it may comprise a fixed function rendering pipeline, including one or more fixed function rendering stages (circuits), such as texture mapping units (texture mappers), blenders, fogging units, etc. In embodiments the renderer comprises a fragment shader (a shader pipeline) (i.e. a programmable processing circuit that is operable to and that can be programmed to carry out fragment shading programs on fragments in order to render them).

The renderer (fragment processing circuit) will process the fragments it receives to then generate output rendered fragment data, which rendered fragment data is then in an embodiment written to an output buffer, such as a frame buffer, in external memory, for use (e.g. to display a frame on a display). The rendered fragment data may be written to the (external) output buffer via an intermediate buffer, such as a tile (e.g. colour) buffer (as will be the case in a tile-based graphics processing system).

As discussed above, as part of the fragment processing operations performed during the further processing pass, the graphics processor is also operable and configured to perform graphics texturing operations, i.e. to apply graphics texture data to sampling positions within the render output.

For instance, when generating a render output (e.g. an image), a graphics processor may perform texturing operations for sampling positions in the render output (image), e.g. to determine the appearance of the render output at those sampling positions. This typically (and in embodiments) involves applying a set of graphics texture data defining the texture surface (e.g. in terms of its colour components (e.g. RGB(A) or YUV values), but optionally also in terms other properties of the texture surface, such as luminance and/or light/shadow, surface normal, etc., values) to respective sampling positions within the render output (image) to determine the appearance (e.g. colour, etc.) that the sampling position(s) should have in the final render output (image).

Thus, graphics texture data, depending on the format in which it is stored and to be used, in embodiments includes a plurality of data “channels” including at least a set of colour (and optionally transparency) channels (e.g. storing the RGB(A) or YUV colour values for the texture surface in question) but optionally also including one or more other channels storing other properties of the texture surface.

The graphics texture data is in embodiments stored in a memory system, which may, e.g., and in embodiments does, comprise a memory that is external to the graphics processor (e.g. main memory). When executing a graphics processing program for which a texturing operation is to be performed, the graphics processor can thus (and does) request graphics texture data for the texturing operation from the memory system, as required, with the requested graphics texture data then being returned to the graphics processor accordingly for use by the graphics processor. Thus, the graphics processing system in embodiments further comprises such memory system for storing graphics texture data.

This transfer of graphics texture data from the (external) memory system in which the graphics texture data is stored into the graphics processor may be, and in embodiments is, facilitated by the use of a dedicated “texture mapping unit” of the graphics processor that is operable to receive texturing requests (requests for texture data) from a graphics processor programmable execution unit and process these texturing requests accordingly. The texture mapping unit is thus a dedicated unit (circuit) associated with, and local to, the graphics processor that provides an interface to the (external) memory system in which the texture data is stored and that is accordingly operable and configured to process any texturing requests issued from the graphics processor programmable execution unit for graphics texture data and return the requested graphics data to the graphics processor programmable execution unit.

In embodiments, the texture mapping unit interfaces, and connects, to a “texture cache system” that is operable to transfer graphics texture data stored in the memory system to the graphics processor for use by the graphics processor when generating a render output (which texture mapping unit is thus operable to receive (load) texture data from the texture cache system and use that texture data to perform texturing operations). That is, rather than the texture data being transferred directly from the (external) memory system to the graphics processor, the texture data is in embodiments transferred via the texture cache (which may itself be part of a larger cache system that is used for transferring such data between the graphics processor and memory). This can then help reduce storage and bandwidth requirements associated with the storage and accessing of the graphics texture data in use.

The texture mapping unit and the texture cache system may thus together form part of a “texture mapping system” (which texture mapping system may include any suitable and desired arrangements of the texture mapping unit and texture cache system) that is operable and configured to handle texturing requests from the graphics processor. Thus, any requests for graphics texture data that is stored in the memory system are in embodiments handled via such texture mapping system (such that the graphics processor in embodiments sends texturing requests to such texture mapping system and receives texturing responses from such texture mapping system (rather than directly to/from the (external) memory system)).

In order to facilitate storing graphics texture data in the memory system, the graphics texture data is in embodiments stored in the (external) memory system in a compressed format. Accordingly, when the graphics processor is performing a texturing operation, in response to the graphics processor requesting graphics texture data from the memory system, the requested graphics texture data must first be processed (i.e. decompressed) into a suitable, uncompressed format in which it can be used by the graphics processor.

Various texture compression/decompression schemes exists that are designed and optimised for compressing/decompressing graphics texture data and a graphics processor may have one or more suitable hardware circuits to support any such texture compression/decompression schemes, as desired (and in embodiments this is also the case for the graphics processor of the technology described herein). In embodiments, (at least some) graphics texture data can be (and in embodiments is) compressed using a neural network based texture compression scheme (and the graphics processor is correspondingly operable to support such neural network based texture processing).

That is, in embodiments, (at least some) graphics texture data is compressed by executing one or more neural networks that are suitably configured (e.g. trained) to compress the graphics texture data. The graphics texture data may therefore be stored in the memory system in a first, compressed format in which neural network based texture compression has been used to compress the graphics texture data. Correspondingly, when such graphics texture data that has been compressed in this way is fetched into the graphics processor from the memory system, the graphics texture data first needs to be decompressed from such (neural network) compressed format in which it is stored in the memory system into a suitable, uncompressed format for use by the graphics processor, and this decompression can be (and is) performed by executing one or more neural networks that are suitably configured (e.g. trained) to perform the required decompression of the graphics texture data into the desired, uncompressed format for use by the graphics processor.

In principle, neural network based texture decompression may also be used for processing graphics texture data that has been compressed in other ways, e.g. using traditional texture compression schemes. That is, rather than only being used to process (decompress) graphics texture data that has been compressed using a neural network based texture compression scheme, it may also be possible to configure and train a neural network to decompress graphics texture data that has been compressed in some other way. In that case, one or more neural network may be used to emulate some or all steps of a more traditional texture decompression scheme. Various arrangements would be possible in this regard.

In this respect, it will be appreciated that machine learning (e.g., and in particular, machine learning using neural networks) is typically good at ‘generalising’ data. For instance, neural networks, after having been trained on a certain body of training data, can then be used to process new (unseen) data, e.g., and in particular, to make inferences from that new data based on the underlying data distribution that was used for the model training. Thus, the present Applicants have found that by appropriate training of a neural network (or set of neural networks), the trained neural network(s) can provide highly efficient compression of graphics texture data (and, correspondingly, similar, e.g. ‘reverse’, neural network(s) can be used to provide effective decompression of graphics texture data that has been compressed in this way).

In particular, compared to traditional graphics texture data compression schemes, neural network based texture processing may often be able to provide relatively higher compression rates and/or image quality.

Neural network based texture processing may also advantageously provide increased flexibility and configurability since the neural network(s) can be suitably configured and trained to compress/decompress graphics texture data in any desired format, and so neural network based texture compression and decompression schemes can be configured to provide any desired number of channels, quality level, compression rate, etc., and then deployed appropriately to do this (whereas existing graphics texture data compression schemes are typically designed only to compress certain formats of data having a fixed number of channels, e.g. RGB (three channels: Red, Green, Blue) or RGBA (four channels: Red, Green, Blue, Alpha), such that where additional channels are desired, these additional channels may need to be stored as a separate graphics texture that has to then be fetched and decompressed separately to the graphics texture storing the colour values, which therefore requires additional memory bandwidth, etc. Storing these additional channels in this manner may also be relatively inefficient as existing graphics texture data compression schemes may not have been optimised for these additional channels, and therefore may not compress these channels particularly effectively).

This neural network based texture processing can be supported in various ways, as desired. For instance, the decompression of the graphics texture data could be done in software, e.g. by the graphics processor programmable execution unit executing suitable compute shader programs to perform the decompression. In some embodiments, however, the graphics processor may comprise a dedicated (hardware) neural network processing circuit (that is separate to the programmable execution unit of the graphics processor) and that is operable to perform the neural network processing for decompressing the compressed graphics texture data. This dedicated (hardware) neural network processing circuit may be dedicated for performing neural network based texture processing or could also be available for other (non-texture related) neural network processing.

Various arrangements would be possible in this regard.

The neural network processing that is performed when processing graphics texture data from the first, compressed format in which it is stored in the memory system to the second, uncompressed format for use by the graphics processor may comprise any suitable and desired processing operations. Further, the neural network processing may be performed for some or all of the graphics texture data that is fetched from memory. That is, a given neural texturing job that is executed by a neural network processing circuit may generally any suitable portion of graphics texture data (and the processing of the graphics texture data could, for example, be divided between multiple neural texturing jobs, if desired).

In fact, a particular effect and benefit of using the neural network based texture compression/decompression schemes of the technology described herein is that this then offers increased flexibility and configurability as to how the graphics texture data is processed (whereas traditional texture compression schemes are typically relatively constrained by what is supported in the respective hardware decompression circuits)).

For example, a single neural network (or set of neural networks) could be configured and trained to process any and all types of graphics textures. However, this may not offer optimal compression/decompression for all different graphics textures, such that for improved performance, it may be desired to have a plurality of different neural networks available that can be selected, e.g. based on the texture (type/content) that is required, to perform the required texture decompression.

In the simplest such case, separate neural networks may be used for each different texture (type/content) and each level of detail. In that case, the graphics processor should select, based on the texture (type/content) and level of detail that is required, the appropriate neural network or networks from a plurality of neural networks that are available and then load data for the selected neural network(s) into the neural processing circuit so that the required graphics texture can be processed using the selected neural network(s) accordingly.

However, the present Applicants recognise that it would also be possible to configure a single, same neural network to perform compression for a group of plural, different (albeit potentially related) textures (such that a corresponding same neural network can perform decompression for any individual textures within that group of textures). For instance, when configuring (training) the neural networks to perform the desired texture compression/decompression, the user or system may select a group of plural, different textures (or texture types) that can/should be compressed/decompressed using the same neural network, and then use that same neural network to individually compress multiple ones of the different textures within the selected group. The selection of which different textures can or should be compressed using the same neural network may be based on various factors including, but not limited to, an expected texture similarity. This could be determined by the user or could also be determined automatically by another neural network as part of the compression process.

In that case, texturing requests for any of the individual textures (types) within a group of plural different textures (types) may be processed using a single, same neural network, thus potentially reducing the instances of having to load/re-load data for multiple different neural networks into the graphics processor.

There are various other possibilities in this regard in terms of exploiting the increased configurability or flexibility that can be achieved using neural network based texture compression/decompression schemes.

The neural networks may generally be configured to perform the desired neural network processing in any suitable manner. Typically this will be done through training of the neural networks, in embodiments in a supervised manner. In embodiments, the training may comprise transfer learning, where a base model is generated and then transfer learning is performed to tune that base model for different output requirements (e.g. different textures, etc., as discussed above), but various arrangements would of course be possible in this regard. Thus, a given neural network can be trained to provide whatever outputs are desired based on an input set of (compressed) graphics texture data. Likewise, multiple neural networks may be used together to extend the range of outputs. Similarly, any suitable neural network architecture (models) may be used. For example, in some embodiments, the neural network(s) may comprise multi-layer perceptrons, such as convolutional neural networks. However, other neural network architecture (models) may also be suitably used.

In embodiments, and in embodiments in addition to any local storage that may be used for storing graphics texture, the neural network processing circuit is also associated with a neural network buffer for storing data (structures) for one or more neural networks (i.e. a model, and its associated weights, etc., defining the neural network, or part thereof) for performing the neural network processing. In order to perform neural network based texture processing, the graphics processor is thus in embodiments operable to load in data (structures) for one or more selected neural networks to such neural network buffer so that the neural network processing circuit can then execute the selected neural networks to perform the desired texture related neural network processing.

It will be appreciated here that loading in data for a neural network may involve loading in a neural network ‘in full’ (i.e. loading in all data, such as weights, etc., required to execute the neural network). However, this is not necessarily the case and in some embodiments the data that is loaded in for storing in the neural network buffer may be less than the ‘full’ neural network. For example, it could be the case that the neural network processing is performed as a number of smaller neural tasks, each of which executes part of the neural network processing (representing a portion of the ‘full’neural network).

Accordingly, according to embodiments, the neural network processing may be executed as a plurality of smaller neural tasks, and the data for each neural task may be fetched (i.e. stored in the neural network buffer), processed, and output (in embodiments to an internal buffer) separately.

It could also be the case, e.g., and in particular, when transfer learning is applied, that the different neural networks may be generated from a same, base neural network such that the different neural networks may each comprise a set of one or more layers that is common to the different neural networks and a set of one or more layers that is specific to that particular neural network. In that case, the common layers may already be stored locally and the data that is to be loaded in may comprise only the layers that are specific to the particular neural network that is required.

Various arrangements would be possible in this regard.

As alluded to above, it will be appreciated that there may be significant bandwidth associated with supporting such neural network based texture processing operations. The technology described herein may therefore be particularly beneficial for graphics processors that support neural network based texture processing as in that context there may be increased bandwidth costs associated with loading in the neural network data structures to perform the required neural network processing, and the particular control operations of the technology described herein may thus be performed to try to re-use some or all of those neural network data structures once they are loaded into the graphics processor for the processing of multiple, different sampling positions. Thus, as mentioned above, the determination of the order in embodiments not only looks for sampling positions that use the same graphics texture data, but also tries to identify sampling positions where the same neural network data structures can be re-used between sampling positions.

Various arrangements would be possible in this regard.

The technology described herein may generally find application in any suitable graphics processing system.

The technology described herein can be used for all forms of output that a graphics processor and graphics processing pipeline may be used to generate. In particular, the technology described herein may be used both for generating graphics processing outputs, such as frames for display, render to texture outputs, etc., or for general purpose (non-graphics) outputs. For example, for graphics outputs, the texture data may relate to colour, etc., data, as discussed above. For general purpose graphics processing operation, texture maps may correspondingly be used to store arbitrary data as desired (with the texturing interpolation/filtering operations then providing means for approximating arbitrary functions with data tables). Various arrangements would be possible in this regard.

In some embodiments, the graphics processor and graphics processing system comprises, and/or is in communication with, one or more memories and/or memory devices that store the data described herein, and/or store software for performing the processes described herein. The graphics processor and graphics processing system may also be in communication with a host microprocessor, and/or with a display for displaying images based on the data generated by the graphics processor and graphics processing system.

In an embodiment, the various functions of the technology described herein are carried out on a single graphics processing platform that generates and outputs the rendered fragment data that is, e.g., written to a frame buffer for a display device.

The technology described herein can be implemented in any suitable system, such as a suitably configured micro-processor based system. In an embodiment, the technology described herein is implemented in a computer and/or micro-processor based system.

The various functions of the technology described herein can be carried out in any desired and suitable manner. For example, the functions of the technology described herein can be implemented in hardware or software, as desired. Thus, for example, the various functional elements, stages, and pipelines of the technology described herein in may comprise a suitable processor or processors, controller or controllers, functional units, circuits/circuitry, processing logic, microprocessor arrangements, etc., that are operable to perform the various functions, etc., such as appropriately configured dedicated hardware elements or processing circuits/circuitry, and/or programmable hardware elements or processing circuits/circuitry that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuits/circuitry, if desired.

Thus the technology described herein extends to a graphics processor and to a graphics processing platform including the apparatus of or operated in accordance with any one or more of the embodiments of the technology described herein. Subject to any hardware necessary to carry out the specific functions discussed above, such a graphics processor can otherwise include any one or more or all of the usual functional units, etc., that graphics processors include.

It will also be appreciated by those skilled in the art that all of the described embodiments and embodiments of the technology described herein can, and in an embodiment do, include, as appropriate, any one or more or all of the optional features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processors, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a graphics processor, renderer or microprocessor system comprising a data processor causes in conjunction with said data processor said processor, renderer or system to carry out the steps of the methods of the technology described herein. Such a computer software carrier could be a physical storage medium such as a ROM chip, RAM, flash memory, CD ROM or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible medium, such as a non-transitory computer readable medium, for example, diskette, CD ROM, ROM, RAM, flash memory or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

Various embodiments will now be described by way of example only and with reference to the figures.

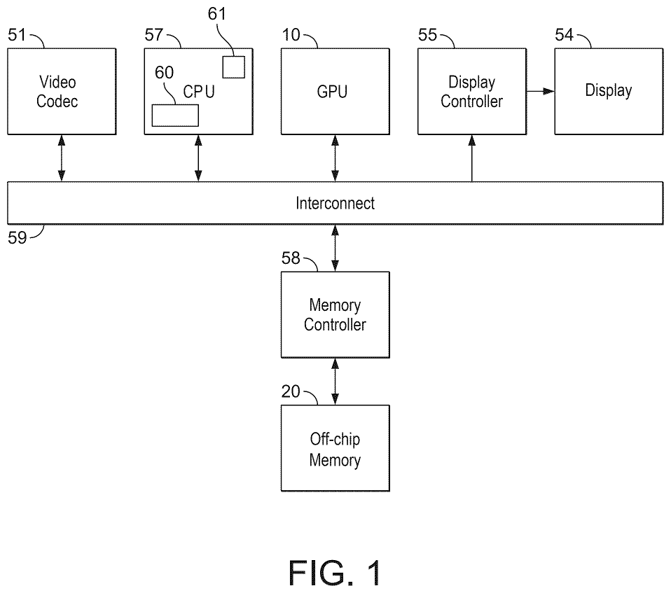

FIG. 1 shows an exemplary data processing system in which the technology described herein and the present embodiment may be implemented.

The exemplary data processing system shown in FIG. 1 comprises a host processor comprising a central processing unit (CPU) 57, a graphics processing unit (GPU) 10, a video codec 51, a display controller 55, and a memory controller 58. As shown in FIG. 1, these units communicate via an interconnect 59 and have access to an off-chip memory system (memory) 20. In this system the graphics processing unit 10, video codec 51, and/or a central processing unit 57 will generate frames (images) to be displayed, and the display controller 55 will then provide the frames to a display 54 for display.

In use of this system, an application 60, such as a game, executing on the host processor (CPU) 57, will, for example, require the display of frames on the display 54. To do this, the application 60 will submit appropriate commands and data to a driver 61 for the graphics processing unit 10 that is executing on the host processor (CPU) 57. The driver 61 will then generate appropriate commands and data to cause the graphics processing unit 10 to render appropriate frames for display and to store those frames in appropriate frame buffers, e.g. in the main memory 20. The display controller 55 will then read those frames into a buffer for the display from where they are then read out and displayed on the display panel of the display 54.

The present embodiments and the technology described herein relate in particular to the situation where the graphics processing unit 10 is using a texture when rendering a frame for output (e.g. for display). Such textures will comprise arrays of data elements (texture elements (texels)), each having an associated data value or values in the data format of the texture in question.

The textures will typically comprise images that are to be applied to graphics entities, such as primitives, to be rendered, and will normally be stored in the off-chip memory 20 from where they can then be read in by the graphics processing unit 10 when required. In particular, when using a texture to generate a render output, the graphics processing unit 10 will fetch the texture data from the memory 20 and store it in a local, texel cache of the graphics processing unit 10. The texture data will then be read from the texel cache, when needed, and used to generate the render output, e.g. frame for display.

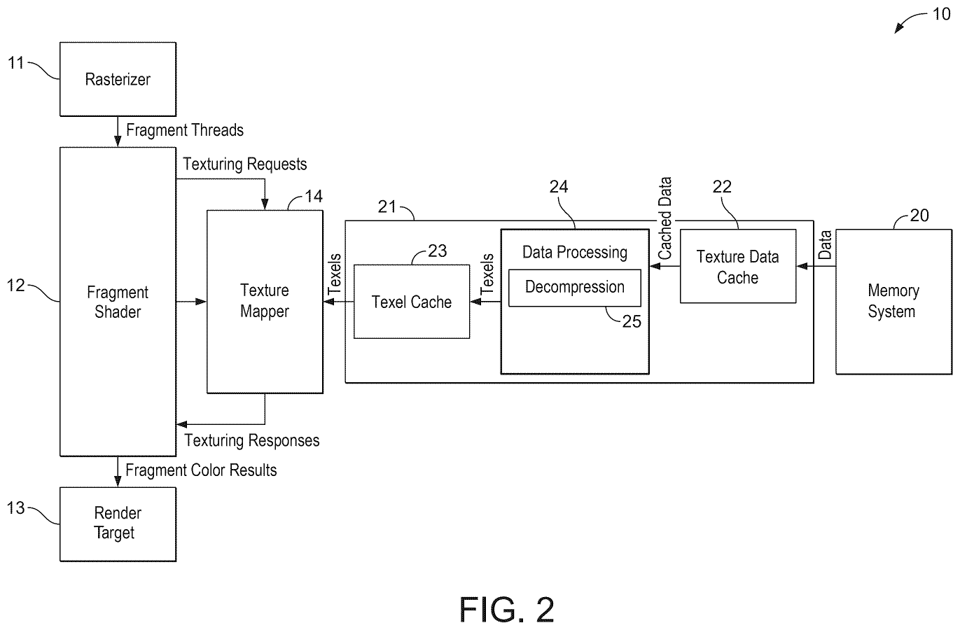

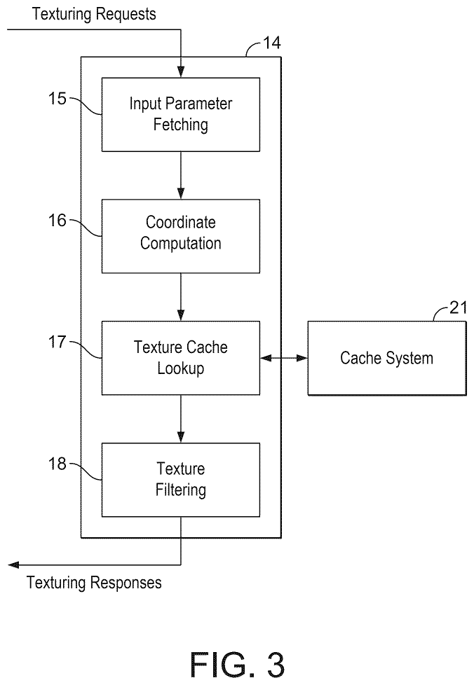

FIGS. 2 and 3 shows schematically the elements of the graphics processing unit 10 of the system shown in FIG. 1 that are particularly relevant to graphics processor texturing operations. As will be appreciated by those skilled in the art, there may be other elements of the graphics processing unit 10 that are not illustrated in FIGS. 2 and 3.

As shown in FIG. 2, the graphics processing unit 10 implements a graphics processing pipeline that includes, inter alia, a rasterizer 11, a renderer in the form of a (programmable) fragment shader 12, a buffer 13 (e.g. in memory 20) for storing the output render target (e.g. frame to be displayed), and a texture mapping unit (texture mapper) 14, and is in communication with the memory system 20.

The system memory 20 will store, inter alia, graphics textures to be used by the graphics processing unit 10. The system memory 20 may, e.g., be main memory (e.g. DDR-SDRAM (Double Data Rate Synchronous Dynamic Memory), non-volatile memory, such as Flash), e.g. a disk drive or other storage medium (e.g. a hard disk, a RAID array of hard disks or a solid state disk (SSD)) of or accessible to the host system in which the graphics processing unit 10 is located, and may be an internal storage medium of the host system, or an external or removable storage medium.

As shown in FIG. 3, the texture mapper 14 may comprise, for example, an input parameter fetching unit 15, a coordinate computation unit 16, a texel cache lookup unit 17, and a texture filtering unit 18.

As shown in FIG. 2, the texture mapper 14 interfaces with the memory system 20 via a texture cache system 21. The texture cache system 21, as shown in FIG. 2, contains a first cache 22 (a “texture data” cache) that receives data from the system memory 20, and a second cache 23 (a “texel” cache) that interfaces with the texture mapper 14 and from which the texture mapper 14 may read data of texels required for its texturing operations. The texture cache system 21 also includes a data processing unit 24 that is operable to read data from the first, texture data cache 22, process that texture data, and then provide that data to the second, texel cache 23.

The first 22 and second 23 caches of the texture cache system 21 are local memory for storing texture data, and may, e.g., comprise a RAM. They may be in the form of an SRAM memory. They each comprise a plurality of cache-lines. The second cache 23 of the cache system 21 may have a greater capacity than the first cache 22, such as having twice or four times as many cache lines as the first cache. Other arrangements would, of course, be possible.

The arrows in FIGS. 2 and 3 indicate the main ways in which data flows between the various components of the graphics processing pipeline and the memory 20. There may also be other communication routes or directions that are not indicated.

The rasterizer 11 receives as its input primitives (e.g. triangles) to be used to generate a render output, such as a frame to be displayed, and rasterizes those primitives into individual graphics fragments for processing. To do this, the rasterizer 11 rasterizes the primitives to sample points representing the render output, and generates graphics fragments representing appropriate sampling positions for rendering the primitives. The fragments generated by the rasterizer 11 are then sent onwards to the fragment shader (renderer) 12 for shading.

The fragment shader 12 executes a shader program or programs for the fragments issued by the rasterizer 11 in order to render (shade) the fragments. The fragments are processed using execution threads in the shader core, with the threads executing the shader program(s) that are to be used to process the fragments. A thread is executed for each sampling position that is to be shaded.

The shader programs may include (zero, one, or more) texturing instructions (texturing operations) that are required to be executed by the texture mapper 14. When a texturing instruction is encountered by the fragment shader 12, a texturing message is sent from the fragment shader 12 to the texture mapper 14, requesting the texture mapper 14 to follow one or more texturing instructions to perform texture processing. After the texture mapper 14 has finished its texture processing (carrying out these instructions), the final result (a texture response) is sent back to the fragment shader 12 in a response message for use when shading the fragment in question.

The texture mapper 14 includes suitable processing circuitry to perform texturing instructions. This processing circuitry may, e.g., be in the form of a dedicated hardware element that is configured appropriately, or it may, e.g., comprise programmable processing circuitry that has been programmed appropriately. In an embodiment, a dedicated hardware texture mapper is used.

The “shaded” fragment from the fragment shader 12 is then stored as part of the output render target in the buffer 13. For example, for a tile-based graphics processor, the buffer 13 may be a tile buffer associated with the graphics processing unit 10, with the contents of the tile buffer, once populated, then being written to the main memory 20, e.g. for subsequent display.

Thus, when instructed by the fragment shader 12, the texture mapper 14 reads textures from the memory 20 (as required), performs various processing steps, and returns a colour sampled from the texture back to the fragment shader 12.

As part of this processing, the input parameter fetching unit 15 may, for example, read in the parameters of the texture to be sampled and the parameters of how to sample the texture from appropriate state information for the texture. For example, the input parameter fetching unit 15 may receive the texturing instruction message from the fragment shader 12 and this message may indicate the texture to be used (e.g. a texture field may be provided that includes a texture descriptor) and the sampling position coordinates at which to perform the texture operation.

The coordinate computation unit 16 may, for example, receive the texturing request message from the fragment shader 12 containing the coordinates to sample in the texture, together with the parameters read by the input parameter fetching unit, and determine the actual texel indices (i.e. the texels or texture data elements) in the texture to be looked up from the texel cache system 21 to perform the texture operation.

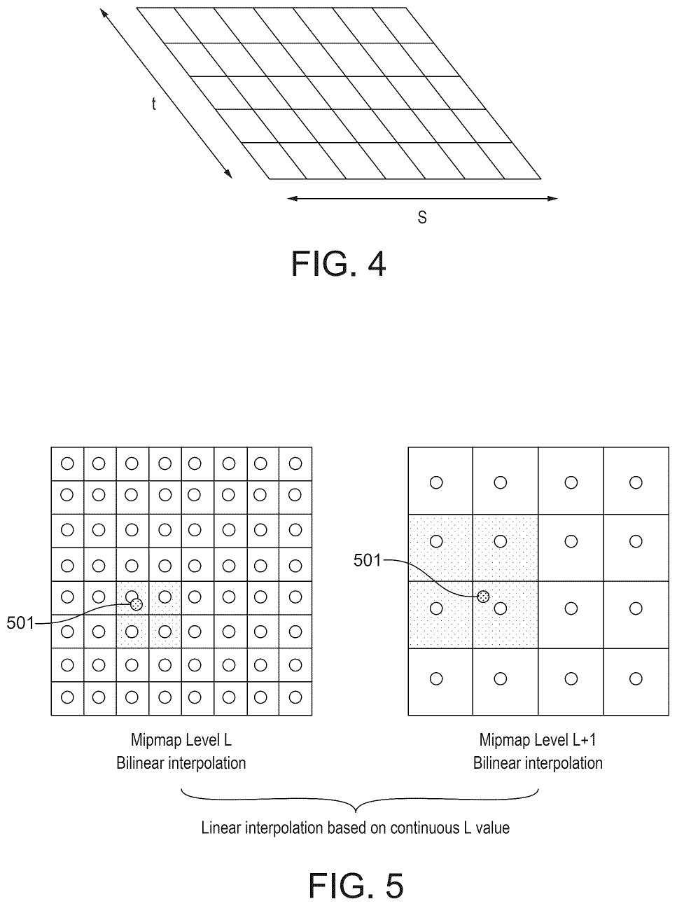

For instance, as mentioned earlier, graphics texture data is compressed in “blocks” to facilitate random access to the graphics texture. FIG. 4 shows an example of (a block of) graphics texture data, in which the texture surface is divided by into subregions that can be addressed based on respective texture surface coordinates (e.g. a pair of (s, t) co-ordinates as shown in FIG. 4). The coordinate computation unit 16 may thus map a texturing request onto the texture surface co-ordinates.

The texture cache lookup unit 17 may, for example, check whether the required texture data (i.e. the block of texture data containing texture data at the specified texture surfaces (s, t) coordinates) is stored in the second (texel) cache 23 of the texture cache system 21 and, if present, read the texture data from the second (texel) cache 23. Thus, the texture cache lookup unit 17 may check whether the required texture data elements (texels) are already stored in the second (texel) cache 23 of the texture cache system 21. If the required data is not cached locally, a request is made to fetch the required data from memory (or from a lower level of the texture cache system 21, as the case may be) into the second (texel) cache 23.

The texturing instruction is then (in embodiments) parked into a parking buffer (not shown) to await further processing (e.g. pending the required data being fetched from the system memory and loaded into the texture cache). Once the required texture data (texture data elements) have been loaded into the second (texel) cache 23, data indicating the cache line and byte offsets where each of the texture data elements required to perform the texture operation are stored in the second (texel) cache 23 so that they can be forwarded to the texture mapper 14 as part of the texturing response.

It will be appreciated in this respect that the graphics texture data elements (texels) will typically have other than a direct correspondence with the sampling positions that are being texture mapped. Thus, further processing is typically performed to determine how the texture should be applied based on the shape, size, angle, scale, etc. of the surface that is being texture mapped. These operations are typically referred to as texture filtering operations (and will also be referred to as such in the present application). Thus, the texture cache lookup may typically lookup plural texels that are then suitably processed/filtered to determine the appearance that the associated sampling position should have.

For instance, for a typical bilinear lookup, texture data from four texels are read from a 2×2 texel region of the texture. The texture filtering unit 18 may, for example, receive the four texels of the bilinear lookup from the texel cache lookup unit, and determine interpolation weights and compute a weighted average of the texture data for the sampling position in question.

To simplify such texture filtering operations, graphics textures are often stored as a set of mipmap levels, with the different mipmap levels representing different resolution versions of the same textures. In that case, the lookup may be for textures from one or more mipmaps levels. For example, when performing anisotropic filtering, texture data from four texels may be read from a 2×2 texel region of each of two mipmap levels of the texture, with filtering then performed between the two mipmaps levels. FIG. 5 shows an example in which a lookup is being performed for a particular sampling position 501. As shown in FIG. 5, bilinear filtering is performed for the texels within respective 2×2 texel regions within two mipmap levels (level L and L+1), and linear interpolation is then performed between the two mipmap levels based on the continuous L value (overall, effectively, trilinear filtering).

Various other arrangements would be possible for filtering the texture data depending on the texture operation that is to be performed.

The filtered (interpolated) texture data for the sampling position in question is then output to (returned to) the fragment shader 12.

To facilitate storing the texture data in the memory 20 the texture data is typically (and in the present embodiment) stored in a compressed format. As mentioned above, this reduces the memory footprint of the textures in the memory 20, and also reduces the bandwidth (and energy) for fetching the texture data into the graphics processor. However, this means that the graphics processing unit 10 therefore needs to decompress texture data that is read in from the memory 20 so that the texture data is decompressed into a suitable format for use by the graphics processing operation for which the texturing request is being made.

The decompression of texture data can be performed at any suitable point along the access path to the memory 20 in which the texture data is stored. For example, as shown in FIG. 2, the data processing unit 24 of the texture cache system 21 includes one or more (hardware) decompression circuits 25 that are operable to perform decompression as data is transferred from the first, texture data cache 22 to the second, texel cache 23. Other arrangements would however be possible. For example, the texture decompression could in principle be performed at other suitable points along the memory access path.

Traditionally, each of the one or more (hardware) decompression circuits 25 supports (only) a single texture compression scheme. Thus, for each texture compression that is desired to be supported, a separate, dedicated decompression circuit 25 may be provided (with other texture compression schemes either being unsupported, or potentially being handled in software, e.g. by executing a compute shader program to perform the required decompression, which is not normally efficient). Because the decompression circuit 25 is designed and optimised for a particular texture compression scheme, this type of arrangement can be relatively inflexible. For example, a given texture compression/decompression scheme may support only a certain number of colour channels (e.g. three colour channels for data in RGB or YUV format, or four colour channels for data in RGBA format). However, modern graphics processing increasingly requires additional channels to be supported, and to address this, those channels may be stored as separate textures which then have to be obtained and decompressed separately to the colour channels.

Neural network processing therefore offers a promising approach for graphics texture compression as neural networks can be suitably configured (i.e. trained) to compress/decompress graphics textures in any desired format, such that neural network based texture compression/decompression can provide a more flexible or configurable approach for processing graphics texture data. For instance, neural network based texture compression offers possibilities for compressing multiple different graphics textures, at multiple different levels of detail, multiple different aspect ratios, etc., using appropriate neural networks. Further, as mentioned above, neural network based texture compression may be able to provide higher compression rates and image quality.

As will be explained further below, the graphics processing unit 10 in the present embodiments is provided with a suitable neural network processing circuit that can be used to perform neural network processing and thus, by loading suitably selected neural networks into the graphics processing unit 10, the neural network processing circuit, can be used to execute the selected neural networks as required in order to perform graphics texture decompression into a desired format.

This therefore provides a more configurable approach as the selected neural network(s) can be loaded in as and when required to perform the desired neural network processing, thus avoiding the constraints associated with using fixed decompression circuits 25, e.g. as may be done in more traditional graphics processor arrangements. Thus, the neural network processing circuit may be configured and optimised for neural network execution, but is free to execute any suitable and desired neural networks, which can provide much greater configurability or support for performing different types of (neural network based texture) compression/decompression schemes. That is, rather than having specific hardware circuits to support specific compression schemes (with multiple different hardware circuits thus being required to support multiple different compression schemes, with associated silicon area costs), the approach according to the present embodiments, where an appropriate neural network processing circuit is available to accelerate neural network processing, means that the same neural network processing circuit (hardware) can be used to execute different neural networks, e.g. by changing the weights/neural network model using software.

In this respect, it will be appreciated that neural networks can be (and already are) used for various image processing operations, including in a graphics processing context for image enhancement (“de-noising”), segmentation, “anti-aliasing”, supersampling, etc., in which case a suitable input image may be processed using a neural network to provide a desired output image, and also for image compression. Neural networks are therefore also well-suited for graphics texture compression.

For instance, a neural network may operate upon suitable input data (e.g. such as an image) to ultimately provide a desired output. In the context of graphics texture compression, a neural network may thus be used to process input data, e.g. in the form of a graphics texture that is to be compressed, into a desired output, in this case a compressed format version of that graphics texture. Correspondingly, another (e.g. ‘reverse’) neural network may be used to process (i.e. decompress) such a compressed format version of a block of graphics texture data back into graphics texture data in a suitable format for use by a graphics processor texturing operation.

These compression/decompression processes may thus generally be considered as examples of neural network “inferencing”processes.

In general, a neural network will typically process the input data (e.g. texture data to be compressed/decompressed) according to a network of operators, each operator performing a particular operation. The operations will generally be performed sequentially to produce desired output data (e.g. based on the input texture data). Each operation may be referred to as a “layer” of neural network processing.

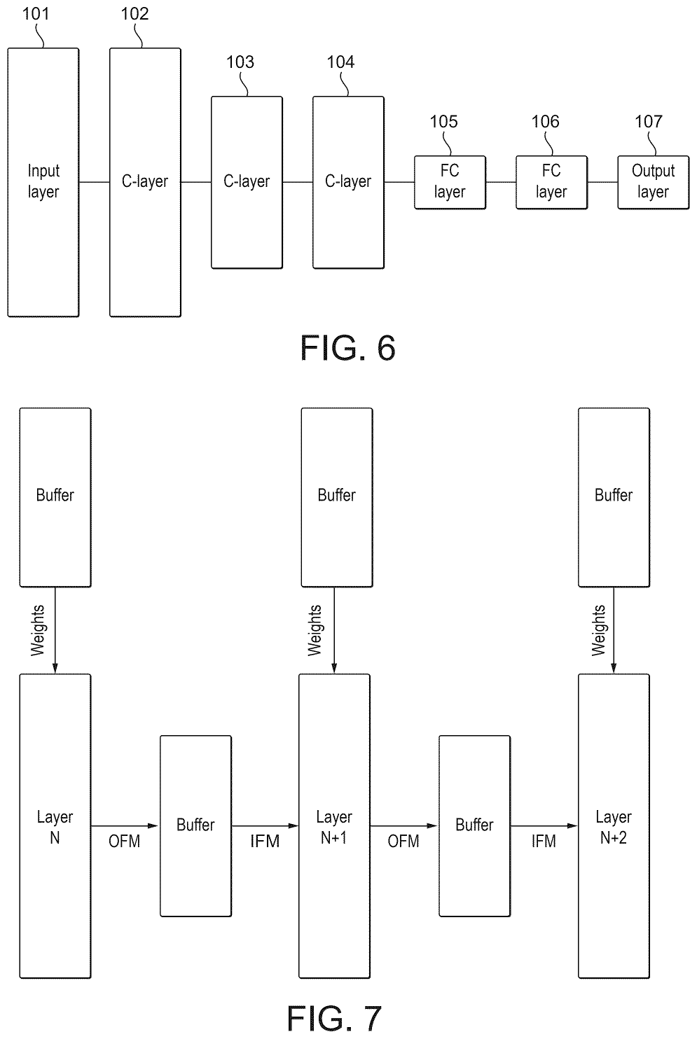

Hence, neural network processing may comprise a sequence of “layers” of processing, such that the output from each layer is used as an input to a next layer of processing. FIG. 6 shows an exemplary sequence of layers of neural network processing from an initial input layer 101 to a final output layer 107, between which are layers comprising various convolutional layers (C-layers) 102, 103, 104, and fully-connected layers (FC layers) 105, 106. Such a neural network may also comprise other additional layer types (which are not shown in FIG. 6), such as a deconvolution layer, as appropriate.

The input layer 101 may be configured to receive input data (e.g. an image to be compressed/decompressed), and to provide that input data in a suitable form (e.g. as an array of data elements, otherwise known as a “feature map”) for use by subsequent neural network layers.

The feature map will generally comprise a three-dimensional array of data elements, each data element having data associated therewith. The feature map may have a width (W), a height (H) and a depth (C), wherein the width (W) and height (H) may be defined as the number of data elements in the width and height direction respectively, and the depth (C) may correspond to a number of data channels. For example, in the case of input data comprising an image (e.g. a graphics texture), the width and height of the array provided by the input layer may correspond to a number of data positions (e.g. pixels/texels) along the width and height direction of the image respectively, whilst the channels may comprise the RGB(A) colour channels of the image. To allow for random access, the image may be compressed and decompressed in multiple, smaller, blocks/regions.

After the input layer, there may be one or more other layers of neural network processing (e.g. including convolutional layers, fully-connected layers, pooling layers, deconvolution layers, or any other layers of neural network processing that may be present).

Generally, a layer of neural network processing will process an input feature map (IFM) in order to generate a corresponding output feature map (OFM) (e.g. in the case of a convolutional layer, deconvolution layer, or pooling layer), or output value (e.g. a probability in the case of a fully-connected layer). The output generated by a layer of neural network processing will be used as the input for a next layer of neural network processing in the sequence, and so on. This is illustrated in FIG. 7.

The operation performed by each layer of neural network processing may comprise any suitable operation which manipulates an input (feature map) to provide an output (feature map). The operation may require process parameters (e.g. such as weights for a filter or “kernel”) which may be specific to a particular layer of neural network processing. Hence, as shown in FIG. 7, suitable process parameters (e.g. weights and biases) may be read from working memory (e.g. a buffer) in order to perform each layer of neural network processing.

With reference to FIG. 6, the final layer of neural network processing in the sequence may comprise an output layer 107. The output layer may process an input feature map to generate useful output data (e.g. an output compressed texture/decompressed texture block in the case of graphics texture data compression/decompression schemes).

Whilst FIG. 6 shows an example of a particular convolutional neural network, it will be appreciated that a neural network may have various other layer types, and/or network architectures (e.g. a recurrent neural network architecture).

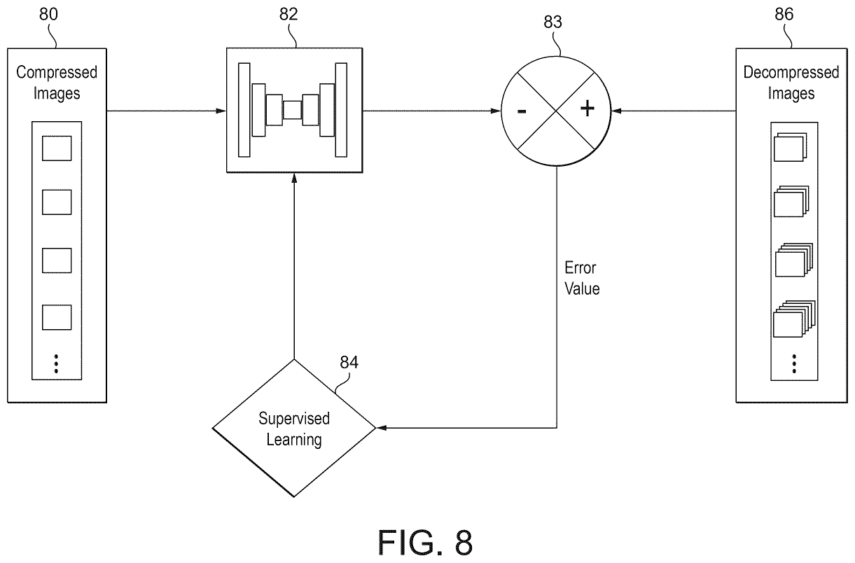

An aspect of the technology described herein therefore relates to the use of neural networks, such as those described above, for graphics texture compression, and correspondingly for graphics texture decompression. For example, as alluded to above, a neural network can be suitably trained to compress graphics texture data (and to do so in such a manner that permits random access to the graphics texture data), and another (reverse) neural network can correspondingly be trained to decompress graphics texture data that has been compressed in this way. This training can be done in any suitably and desired manner for training a neural network. For example, in embodiments, this is done by a process of “supervised learning”, as shown in FIG. 8.

FIG. 8 thus shows schematically an example of a training process in which supervised learning is performed (at step 84) in order to train a neural network 82 to perform graphics texture compression/decompression. In particular, in this example, the neural network 82 is being trained to perform graphics texture decompression. In this case, a set of compressed image regions (i.e. “blocks” of compressed texture data) 80 is provided as input to the neural network 82. The neural network 82 then learns to decompress these compressed images/regions 80 by comparing its output with a corresponding set of ground truth decompressed images/regions 86 (at step 83) and using the resulting error value to guide the supervised learning (step 84). In this example, the neural network 82 learns to decompress each channel individually. Also, each channel in the compressed texture has the same width and height.

However, the training can generally be done in various ways as desired depending on the neural network processing that the neural network(s) is desired to do, as will be discussed further below.

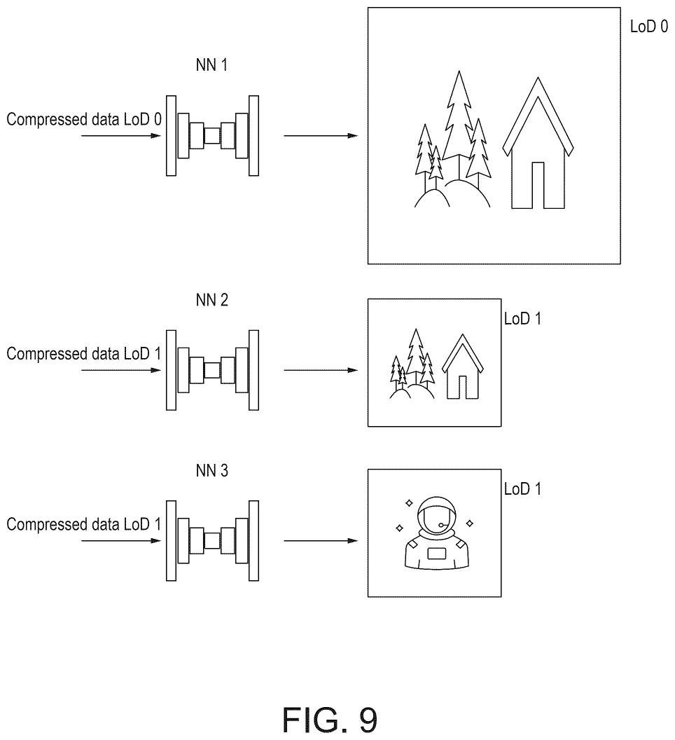

For example, FIG. 9 shows a plurality of different neural networks that have been trained separately (although transfer learning may generally be used for this training) with each neural network being configured and training to process a different type of texture data (in this example at a single level of detail). Thus, as shown in FIG. 9, a first neural network (NN1) may be provided that is configured to output a first texture at a first level of detail (LoD0). Correspondingly a second neural network (NN2) is provided that is configured to output the same first texture but at a second level of detail (LoD1). FIG. 9 also shows a third neural network (NN3) that is configured to output a second, different texture at the second level of detail (LoD1). In this way, many different neural networks may be trained and the appropriate neural network can then be selected, as will be discussed further below, depending on the texture that is required, the desired level of detail, etc., and loaded in to the graphics processor accordingly to perform the neural network texture decompression.

Although in FIG. 9 there are respective, different neural networks for different textures and levels of detail, it will be appreciated that this need not be the case, and a given neural network may generally be operable and configured to process different types of texture, at different levels of detail, etc. Thus, a particular benefit of neural network based texture compression/decompression schemes is that by suitable configuration and training of a neural network (or set of neural networks) it is possible to extend or generalise the functionality of the neural network, thus potentially reducing the number of different neural networks that may be required (and hence potentially reduce memory bandwidth).

It will be appreciated from the above examples that neural network processing may thus provide various benefits in the context of graphics texture compression/decompression such that it is desirable to more efficiently support such neural network based texture compression/decompression on graphics processors.

This support could be achieved by including a suitable (dedicated) neural network texture decompression circuit, e.g. as another decompression circuit 25 within the data processing unit 24 of the texel cache system 21, and providing suitable interfaces for that network texture decompression circuit to load in any selected neural networks, as required.

In this respect, the present Applicants however recognise that there are various other examples of (non-graphics texture related) neural network processing that may be performed when performing graphics processing, and that it may already be advantageous for the graphics processor to have a separate on-chip neural engine to support this, which (existing) neural engine can therefore advantageously also be used to support neural network based texture compression/decompression schemes.

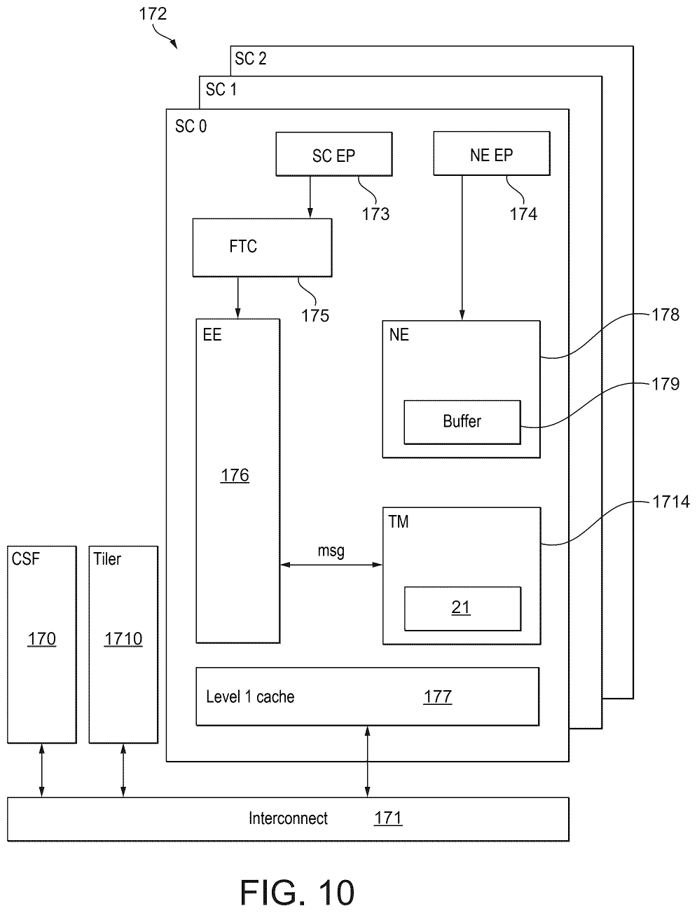

An example of a graphics processing unit including such a neural engine is shown in FIG. 10. FIG. 10 shows schematically certain relevant elements and components of a graphics processing unit.

As shown in FIG. 10, the graphics processor includes one or more shader (processing) cores 172 that are provided along the same interconnect 171 (which interconnect 171 may, for example, provide communication to a shared (L2) cache (not shown) which is operable to communication with the off-chip memory system).

A command processing circuit (in the form of a command stream frontend, “CSF”) 170 is also provided that is operable to communicate over the interconnect 171 with the respective shader (processing) cores 172 to schedule processing jobs. In the present embodiments the graphics processor is operable to perform tile-based rendering and so also includes a separate tiler unit 1710 that is also operable to communicate over the interconnect 171 with the respective shader (processing) cores 172 to perform tiling operations.

FIG. 10 shows schematically the relevant configuration of one shader core (SCO), but as will be appreciated by those skilled in the art, any further shader cores 172 of the graphics processor will be configured in a corresponding manner.

As will be appreciated by those skilled in the art there may be other elements of the graphics processor that are not illustrated in FIG. 10. It should also be noted here that FIG. 10 is only schematic, and that, for example, in practice the shown functional units may share significant hardware circuits, even though they are shown schematically as separate units in FIG. 10. It will also be appreciated that each of the elements and units, etc., of the graphics processor as shown in FIG. 10 may, unless otherwise indicated, be implemented as desired and will accordingly comprise, e.g., appropriate circuits (processing logic), etc., for performing the necessary operation and functions.

As shown in FIG. 10 the (and each) graphics processor shader (processing) core (SCO) comprises a programmable processing unit (circuit) in the form of execution engine (EE) 176 that perform processing operations by running small programs (often referred to as “shader” programs) for each “item” in an output to be generated such as a render target, e.g. frame. (An “item” in this regard may be, e.g. a vertex, one or more sampling positions, etc.) The shader cores will process each “item” by means of one or more execution threads which will execute the instructions of the shader program(s) in question for the “item” in question. Typically, there will be multiple execution threads each executing at the same time (in parallel).

The shader (processing) core (SCO) may also include, for example, an instruction cache (not shown) that stores instructions to be executed by the execution engine 176 to perform graphics processing operations.

The shader (processing) core (SCO) also includes an appropriate local (L1) cache 177, that is operable, e.g., to load into an appropriate cache, data, etc., to be processed by the execution engine 176, and to write data back to the memory system (via any shared cache system when present) (for data loads and stores for programs executed in the execution engine 176).

As shown in FIG. 10, the shader (processing) core (SCO) also includes a texture mapper unit in the form of texture mapping apparatus 1714, which is in communication with the execution engine 176, and which is operable to perform texturing operations. The texture mapping apparatus 1714 includes suitable processing circuitry to follow texturing instructions. In the present embodiments, this processing circuitry is in the form of one or more dedicated hardware elements that are configured appropriately, e.g. as discussed above. The texture mapping apparatus 1714 has a local buffer, which may correspond to texture cache system 21 discussed above, and is in embodiments also operable to fetch data from the memory system (although this is not shown in FIG. 10).

In order to perform graphics processing operations, the execution engine 176 will execute graphics shader programs (sequences of instructions) for respective execution threads (e.g. corresponding to respective sampling positions of a frame to be rendered). Accordingly, as shown in FIG. 10, the shader core (SCO) further comprises a shader core endpoint 173 that is operable to schedule processing work to the execution engine 176 and a corresponding fragment thread creator (generator) 175 that is operable to generate execution threads for execution by the execution engine 176 as desired. The fragment thread creator (generator) 175 in the present embodiments also includes a rasterizer, as will be explained further below.

The command stream frontend 170 may thus issue fragment processing jobs to the shader core endpoint 173 of a respective shader core accordingly. The command stream frontend 170 is also generally able to schedule other desired processing work for the graphics processor, including both normal graphics processing work, as well as compute and neural network processing work.

To facilitate the performance of neural network processing work using the graphics processor, the shader cores 172 of the graphics processor are in the embodiment shown in FIG. 10 each provided with a respective neural network processing circuit (neural engine, “NE”) 178. In FIG. 10, the neural engine 178 is provided with its own separate neural endpoint 174 to which neural network processing jobs can be submitted by the command stream frontend 170. The neural engine 178 is also provided with a respective neural buffer 179 for storing the required data for the neural network processing (which may include the data defining the neural network itself, including the weights, biases, etc., as well as the input/output feature maps for the neural network processing).

Thus, in FIG. 10, neural network processing work may be triggered by the command stream frontend 170 issuing a suitable processing task to a respective graphics processor shader core, which task is then scheduled to the neural engine 178 by the separate neural endpoint 174.

Thus, the graphics processing unit in FIG. 10 includes a dedicated “on chip” neural network processing circuit that is associated with, and local to, the graphics processor itself. This then means that the neural network processing circuit is operable, e.g., to utilise some of the graphics processor's existing resource (e.g. such that at least some functional units and resource (e.g. the overall job control, and any shared storage) of the graphics processing unit can effectively be shared between the neural network processing circuit and execution unit, for instance), whilst still allowing an improved (more optimised) performance compared to, e.g., the graphics processor only being able to perform neural network processing with general purpose execution in the execution unit (or using an entirely separate unit that is independent of the graphics processor, such as an entirely separate neural processing unit, “NPU”, that is operable to perform neural network processing on demand by the host processor (CPU) 57 and that is provided along the same interconnect (bus) 59 in parallel with the graphics processing unit 10).

The arrangement shown in FIG. 10 can thus work well to perform some neural network processing locally to the graphics processor. This can be particularly useful for neural network processing relating to other graphics processing operations such as when performing so-called “super sampling” and/or other “anti-aliasing” techniques using deep learning processing. Another example might be for de-noising applications when performing a ray tracing process.

The arrangement shown in FIG. 10 can also be used in the same way to perform neural network based texture decompression.

Thus, when performing fragment processing jobs, the command stream frontend 170 may send a processing job to the shader core endpoint 173, which then sends the primitives that are to be processed to the fragment thread creator 175. The fragment thread creator 175 then sends tasks to the execution engine 176 to execute the desired shader program. The execution engine 176 then executes instructions from the shader program. In response to executing a texturing instruction, the execution engine 176 then messages the texture mapping unit (texture mapper) 1714, e.g. in the normal manner, to request the required graphics texture data.

Thus, in the present embodiments, in the same manner described above, the texture mapping unit (texture mapper) 1714 checks its buffer (e.g. the texture cache system 21) to determine whether the requested texture data (at the desired (s, t) co-ordinates) has already been decompressed and is already locally available. If so, i.e. if there is a hit in the texture cache system 21, the requested texture data is returned from the buffer to the texture mapping unit (texture mapper) 1714, filtered (interpolated) as required, and the filtered (interpolated) value is then returned to the execution engine 176.

On the other hand, if the requested texture data is not already locally available (i.e. there is a miss in the texture cache system 21), that texture data needs to be fetched in by the texture mapping unit (texture mapper) 1714 and then suitably decompressed for use by the graphics processor. When neural network based texture decompression is being performed, if new graphics texture data needs to be fetched in, the corresponding neural network data or data structures for processing that graphics texture data also (first) need to be loaded in (e.g. to the neural buffer 179 of the neural engine 178) so that the graphics texture data can be processed accordingly.

Thus, if the requested texture data is not already locally available in the texture cache system 21, the requested texture data is fetched in via the texture cache system 21, and then decompressed, but prior to (on in parallel with) fetching in the compressed texture data, the corresponding neural network data or data structures for processing that graphics texture data are also fetched. The compressed texture data is then processed accordingly using the corresponding neural network, and the decompressed texture data is then placed into the texture cache system 21 appropriately so that it can then be returned to the texture mapping unit (texture mapper) 1714, and ultimately to the execution engine 176.

Thus, in the present embodiments, the neural network based texture compression is supported by the neural engine 178 which acts in cooperation with the texture mapping system (i.e. the texture mapper 14 and texture cache system 21) to process any texture data that is to be decompressed by executing a corresponding set of neural networks.

Various other arrangements would of course be possible for supporting neural network based texture compression within a graphics processing unit.

It will be appreciated from the above that there may be significant memory bandwidth and/or processing latency associated with such graphics texturing operations when fetching in graphics texture data, especially when neural network based texture processing is performed such that it is not only the graphics texture data that needs to be fetched, but also the neural network data or data structures for processing that graphics texture data.

The present embodiments thus provide an improved graphics processor operation in which the processing is performed to (try to) reduce the memory bandwidth and/or processing latency associated with the graphics texturing operations.

Various embodiments will now be described in the context of a tile-based rendering system. It will be appreciated however that the technology described herein may also generally find application in other (e.g. immediate mode) rendering systems.

In a tile-based rendering system, the two-dimensional graphics processing (render) output (i.e. the output of the rendering process, such as an output frame to be displayed) is generated (rendered) as a plurality of smaller area regions, usually referred to as “tiles”. The render output is typically divided (by area) into regularly-sized and shaped rendering tiles (they are usually e.g. squares or rectangles).

When performing tile-based graphics processing, there will normally be some initial geometry processing, such as vertex processing (vertex shading) of attributes for vertices to be used for primitives for the render output being generated, to generate geometry (and other) data required for rendering the graphics processing output. The geometry processing will then be followed by a tiling/binning process that generates appropriate “binning” data structures for determining which geometry (e.g. primitives) needs to be processed for respective rendering tiles of the output being generated.

The tiles are each rendered separately (e.g. one after another). The rendered tiles are then combined to provide the complete render output (e.g. frame for display).

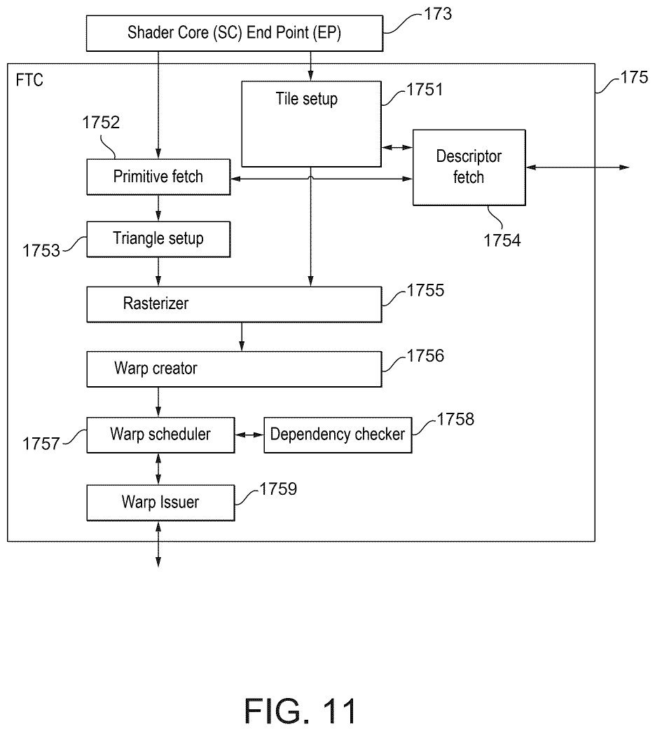

FIG. 11 shows in more detail the fragment thread creation process in a more traditional graphics processing unit when performing tile-based rendering.

Thus, as discussed above, in response to a command to render a particular tile, the shader core endpoint 173 may issue a rendering job to the fragment thread creator (generator) 175 for rendering the tile in question. A tile setup unit 1751 sets up the tile that is to be rendered based on suitable tile descriptors fetched in via descriptor fetch unit 1754. In parallel with this, primitive fetch unit 1752 fetches in the primitives that are to be processed for the current tile (e.g. by reading the appropriate “binning”data structures associated with that tile).

These primitives are then processed by a suitable pipeline of fragment frontend stages including a triangle (primitive) setup stage 1753 that performs primitive setup and a rasterizer 1755 that rasterises the primitives into respective fragments falling within the particular tile to be rendered. Warp creator 1756 then creates suitable execution thread groups (warps) for processing those fragments, and the warp scheduler 1757 then schedules these execution thread groups (warps) for execution (e.g. based on the dependency checker 1758) by the execution engine 176. The warp issuer 1759 issues the execution thread groups (warps) to the execution engine 176 according to the desired schedule. A fragment shader is then executed to perform further fragment processing.

In more traditional graphics processor operation, the rendering operation for a given tile is typically performed in a single pass, with the fragment shader executed after the fragment frontend stages generating the final output values for the tile. In the present embodiments, however, the rendering pipeline is instead implemented by performing two separate fragment processing passes, namely an initial processing pass that generates a set of fragment visibility information as to which primitives are visible at which sampling positions but does not process the fragments to completion to generate the final output values, as the final fragment processing operations are instead deferred to a subsequent further processing pass.

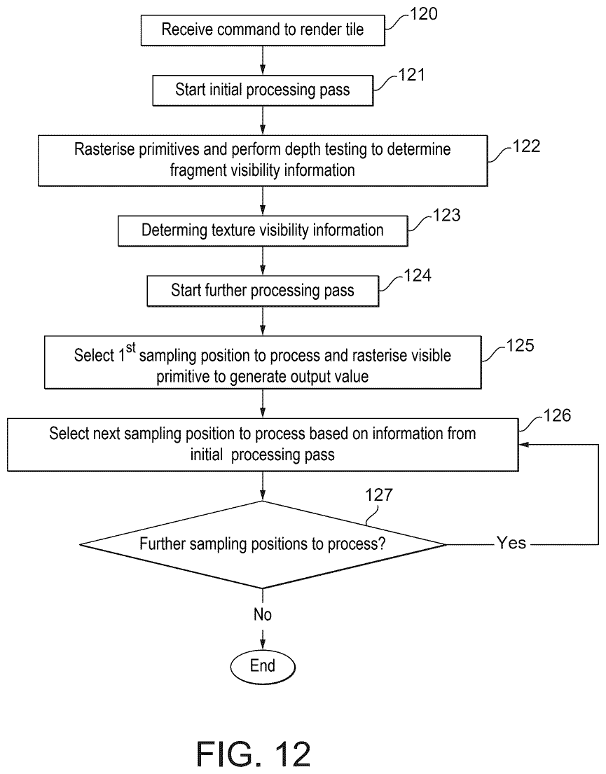

Thus, as shown in FIG. 12, in response to a command to render a tile (step 120), an initial processing pass is performed in respect of that tile (step 121). The initial processing pass rasterises the primitives to be processed for that tile into respective fragments and performs depth testing to determine which fragments (of which primitives) are visible at which sampling positions within the tile (step 122). As will be explained further below, the fragment visibility information is optionally then further processed to determine corresponding texture visibility information (step 123), indicating which graphics textures are visible at which sampling positions. The initial processing pass however stops at this point without generating the final render output values.

A subsequent further processing pass is then performed (step 124) to generate the final render output values. The further processing pass thus selects a first sampling position within the tile to process and rasterises the primitive that is visible at that sampling position to generate a respective output value (step 125). The further processing pass then selects a next sampling position to process (step 126), and so on, until there are no further sampling positions to process (step 127—no), at which point the further processing pass is finished, and the rendering of the tile is complete.

This process will then be repeated for the next tile, and so on, until the entire render output has been generated.

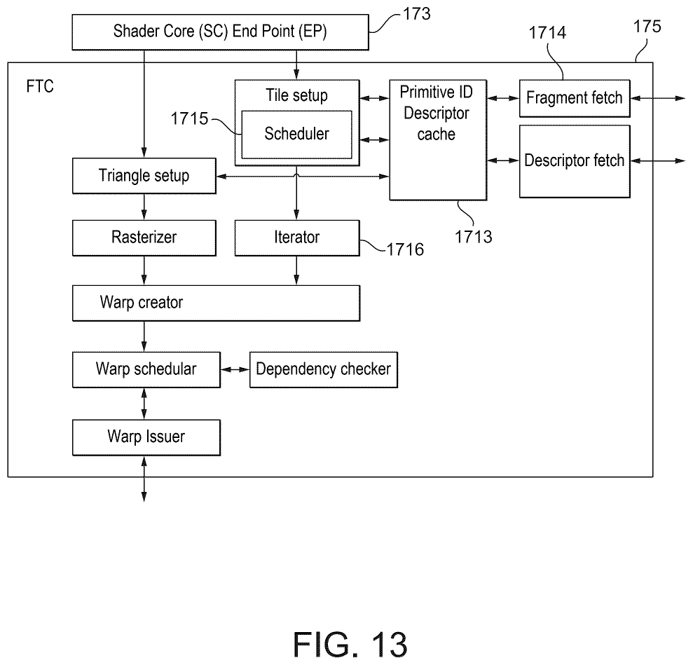

FIG. 13 shows the fragment thread creation in a graphics processing unit according to an embodiment in which additional hardware circuitry is provided to manage this two-pass operation. Thus, in the initial processing pass, execution thread groups (warps) are created for processing the fragments output from the rasterizer 1755 to determine a set of fragment visibility information. This is done by depth testing the fragments. The initial processing pass thus writes the depth buffer and also writes a suitable identifier of the primitive (fragment) that is visible at each sampling position within the tile.

During the further processing pass, the fragments are fetched for processing by fragment fetch unit 1714, and the set of fragment visibility information generated by the initial processing pass as to which primitives are visible at which sampling positions is then used together with information stored in a primitive ID descriptor cache 1713 as to which textures are to be applied for which primitives to determine an order in which the sampling positions should be processed. This is done in FIG. 13 by scheduler 1715 within tile setup unit 1751 and is fed to iterator 1716 that then creates suitable execution thread groups (warps) for processing the sampling positions in the desired order. The further processing pass then processes the primitives (fragments) that are visible at those sampling positions to generate the final output values.

Thus, it will be appreciated that in the technology described herein, some of the processing that is performed in the initial processing pass is essentially repeated during the further processing pass. The effect and benefit of performing the rendering in two separate passes however is that this then allows the further processing pass to be controlled based on the information gathered by the initial processing pass. In particular, according to the present embodiments, the order in which sampling positions are processed within a tile is controlled to try to optimise that order to increases instances where the same data or data structures can be used for the processing of consecutive sampling positions. This can in turn reduce the overall memory bandwidth and/or processing latency associated with the rendering of the tile.

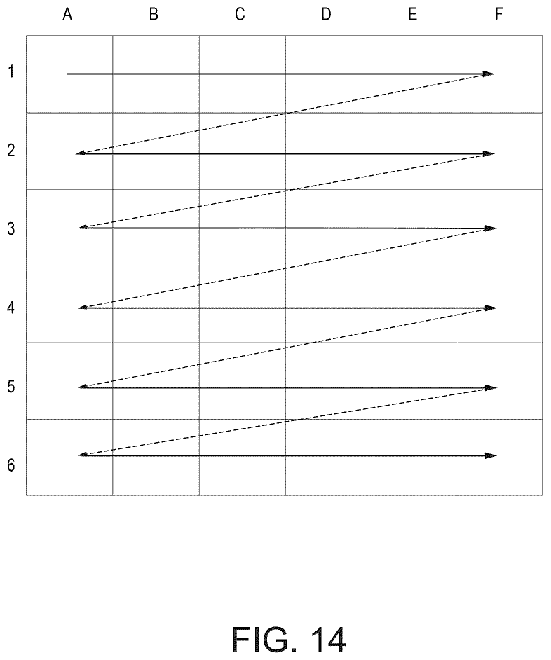

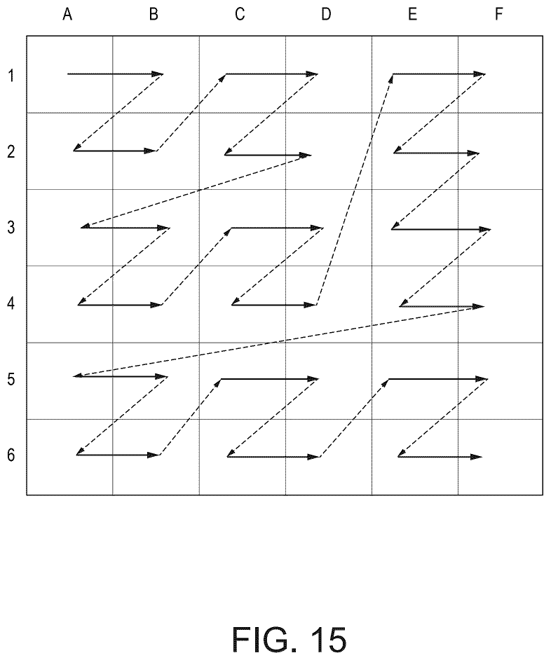

For instance, in a traditional tile-based rendering system, there will typically be a certain ‘set’ (or fixed) processing order for the sampling positions within a tile. FIG. 14 thus shows an example of a tile that comprises a 6×6 array of sampling positions (although it will be appreciated that rendering tiles will typically be larger than this, e.g. 16×16 or 64×64 sampling positions), in which when processing the tile, the sampling positions within that tile are processed according to scan line order. Other arrangements would however be possible, for example, using space-filling curves to try to increase spatial locality. An example of this is shown in FIG. 15 in which the sampling positions are processed according to a Morton (or “Z”) order. However, the present Applicants recognise that any particular ‘set’ (fixed) processing order may not necessarily be optimised for the tile in question.

According to the technology described herein, therefore, rather than always using a certain ‘set’ (or fixed) processing order for the sampling positions within a tile, the order in which the sampling positions is processed during the further processing pass is controlled based on the information gathered by the initial processing pass. This can then allow the order to be controlled, e.g., and in embodiments, to increase instances where the same data (structures) are used for consecutive sampling positions, hence reducing memory bandwidth and/or processing latency associated with fetching that data in.

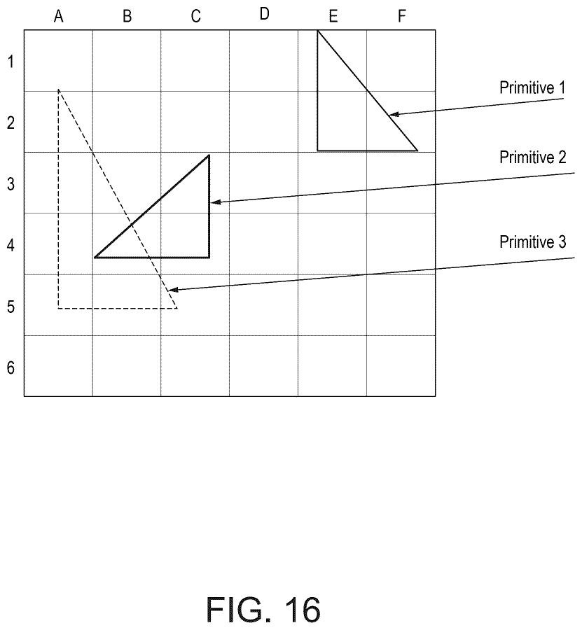

To illustrate this, FIG. 16 shows an example scene in which there are three primitives to be rendered within a particular tile.

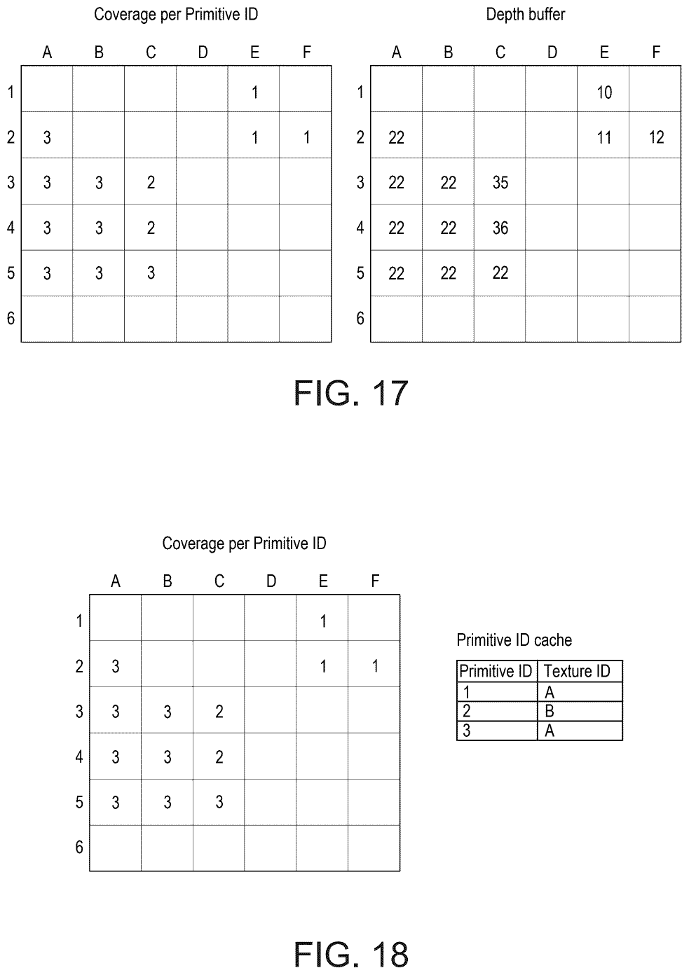

The initial processing pass will thus process these primitives (and in embodiments only these primitives) to populate the set of fragment visibility and depth buffer for this tile. FIG. 17 thus shows the result of depth buffer and the fragment visibility information, i.e. the coverage per primitive ID, at the end of the initial processing pass. In particular, as shown in FIG. 17, the coverage per primitive ID identifies (directly) which primitives are visible at which sampling positions within the tile.

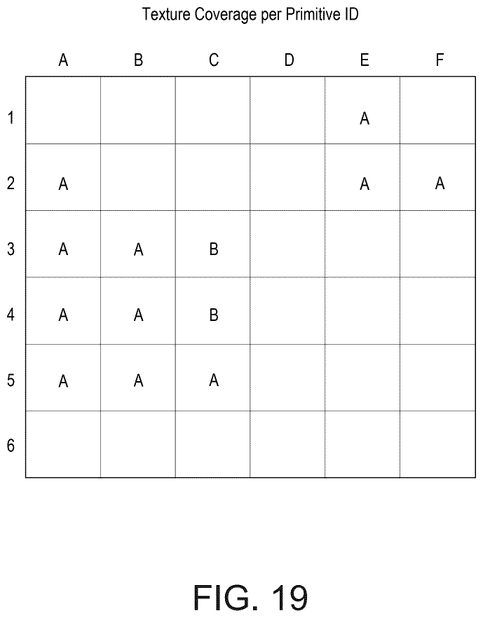

From this information, it can then be determined which graphics texture data needs to be applied at which sampling positions. For instance, FIG. 18 shows an example of a primitive ID descriptor cache (i.e. the primitive ID descriptor cache 1713 in FIG. 13) that is effectively a lookup table for which primitives use which textures. FIG. 19 shows another embodiment where the texture coverage per primitive ID is explicitly generated based on this (e.g. by iterating over the coverage per primitive ID).

This information as to which texture are visible at which sampling positions, however it is generated, can then be used as discussed above to control the order in which sampling positions are processed, in particular to (try to) process sampling positions where the same texture data is required relatively closer together, e.g. in consecutive order. This can then reduce the memory bandwidth and/or processing latency associated with the graphics texturing operations associated with the processing of those sampling positions since the cache hit rate can be increased, thus reducing the need to repeatedly re-fetch and re-process the (same) graphics texture data.

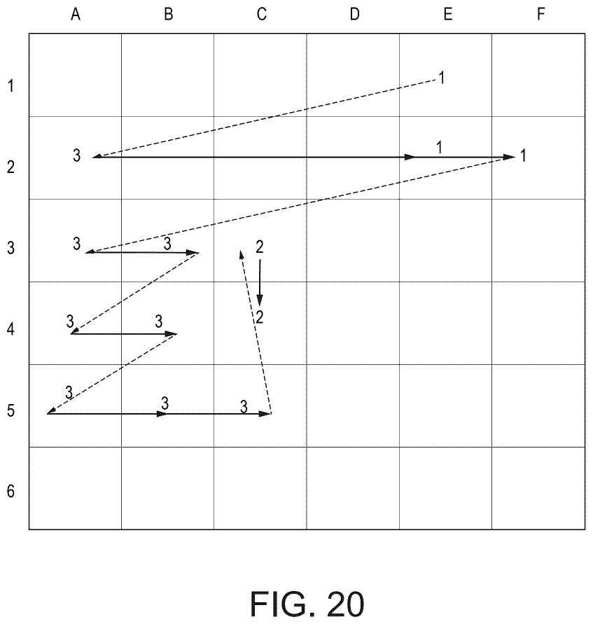

Thus, as shown in FIG. 20, in this example, the order in which sampling positions are processed is controlled such that sampling positions that need the same texture data are processed consecutively.

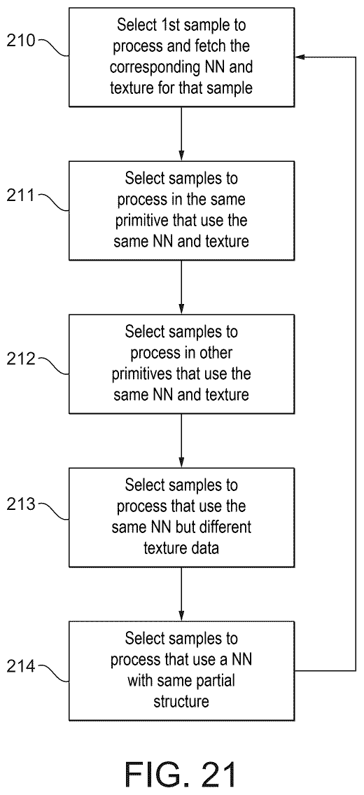

In this example, the order is controlled based on which sampling positions require the same graphics texture data. Various heuristics may however be applied in this regard to control the order in which sampling positions are processed during the further processing pass. FIG. 21 shows an example of a set of heuristics that may be cumulatively applied to determine the order in which sampling positions should be processed.

Thus, as shown in FIG. 21, for a given (first) sampling position that has been selected for processing, the required texture data and corresponding neural network for processing that texture are loaded in (step 210) (and the processing of that sampling position can then be performed accordingly). In the next step, the determination looks for other sampling positions within the same primitive that use the same texture (and hence can be processed using the same neural network), and selects those sampling positions accordingly for processing (step 211). Once all sampling positions within the same primitive that use the same texture and same neural network have been processed, the determination may then look for sampling positions in other primitives that use the same neural network and same texture, and select those sampling positions for processing (step 212). Once all sampling positions that use the same neural network and same texture have been selected (and processed), the determination may then look for and select for processing sampling positions that use the same neural network but for different texture data (i.e. with different input data) (step 213). The determination in this example thus avoids having to repeatedly load that same neural network into the graphics processor by attempting to select sampling positions that can be processed using the same neural network for processing in consecutive order.

At some point all of the sampling positions that can be processed with that same neural network will have been processed. However, before switching to another neural network, the determination in FIG. 21 checks then whether there are any sampling positions for which the required neural network has the same partial structure (e.g. it has some layers in common with the currently loaded neural network) (step 214). If so, the processing should then move to those sampling positions, as this at least avoids having to load the full neural network into the graphics processor.

Various other arrangements would be possible in this regard.

It will be seen from the above that the present embodiments may therefore provide improved graphics processor operation in which the rendering operations are performed in two separate passes, and in which information generated by the initial processing pass is then used to control the further processing pass. For example, this can then provide various benefits in terms of reduced overall memory bandwidth and/or increased processing throughput (reduced latency) associated with handling graphics processing texturing requests.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A method of operating a graphics processor to generate a render output, the method comprising:
for a sequence of primitives to be processed for the render output:
performing an initial processing pass comprising processing primitives within the sequence of primitives into respective sets of one or more fragments, each fragment associated with a respective set of one or more sampling positions within the render output, and then processing the resulting fragments to determine which particular primitives in the sequence of primitives are visible for which sampling positions within the render output; and
thereafter performing a further processing pass to generate respective output values for the respective sampling positions within the render output, the further processing pass comprising, for each sampling position for which an output value is to be generated, generating a respective output value for the sampling position by performing further processing of the particular primitive in the sequence of primitives that is visible at that sampling position,
wherein a set of information is generated from the processing of the sequence of primitives by the initial processing pass as to the further processing of primitives that is to be performed in respect of particular sampling positions within the render output when generating the respective output values for those particular sampling positions, and wherein the method further comprises:
controlling an order in which the sampling positions are processed during the further processing pass based on the set of information generated from the processing of the sequence of primitives by the initial processing pass.

2. The method of claim 1, wherein the generating of a respective output value for a sampling position by performing further processing of the particular primitive in the sequence of primitives that is visible at that sampling position includes applying graphics texture data associated with that particular primitive to the sampling position, and wherein the set of information is generated from the processing of the sequence of primitives by the initial processing pass is usable to identify which graphics texture data is to be applied at which sampling positions within the render output.

3. The method of claim 2, wherein the initial processing pass generates a set of primitive identifying information for the sequence of primitives, the set of primitive identifying information identifying for respective sampling positions in the render output the particular primitive that is visible at that sampling position, the method further comprising:
prior to the further processing pass:
processing the set of primitive identifying information for the sequence of primitives to determine a corresponding set of texture identifying information, the set of texture identifying information identifying for respective sampling positions in the render output particular graphics texture data that is to be applied for that sampling position.

4. The method of claim 2, wherein controlling an order in which the sampling positions are processed during the further processing pass comprises identifying a group of sampling positions for which the same graphics texture data is to be applied, and processing the sampling positions in the identified group of sampling positions in consecutive order.

5. The method of claim 2, wherein the graphics processor supports neural network based texture processing in which when graphics texture data is loaded into the graphics processor during the further processing pass, the graphics texture data is processed into a format for use by the graphics processor by one or more neural networks, and wherein controlling an order in which the sampling positions are processed during the further processing pass comprises identifying a group of sampling positions for which some or all of the same neural network data or data structures are to be used, and processing the sampling positions in the identified group of sampling positions in consecutive order.

6. The method of claim 1, wherein the generating of a respective output value for a sampling position by performing further processing of the particular primitive in the sequence of primitives that is visible at that sampling position includes executing one or more fragment shader, and wherein the set of information generated from the processing of the primitives during the initial processing pass is usable to identify which fragment shader is to be executed in respect of which sampling positions.

7. The method of claim 6, wherein the initial processing pass generates a set of primitive identifying information for the sequence of primitives, the set of primitive identifying information identifying for respective sampling positions in the render output the particular primitive that is visible at that sampling position, the method further comprising:
prior to the further processing pass:
processing the set of primitive identifying information for the sequence of primitives to determine a corresponding set of texture identifying information, the set of texture identifying information identifying for respective sampling positions in the render output a particular fragment shader that is to be executed in respect of the processing for that sampling position.

8. The method of claim 6, wherein controlling an order in which the sampling positions are processed during the further processing pass comprises identifying a group of sampling positions for which the same fragment shader is to be executed, and processing the sampling positions in the identified group of sampling positions in consecutive order.

9. The method of claim 1, wherein controlling an order in which sampling positions are processed for the further processing pass comprises determining a desired order in which sampling positions are to be processed prior to starting the further processing pass.

10. The method of claim 1, wherein controlling an order in which sampling positions are processed for the further processing pass comprises determining, during the further processing pass, for a particular current sampling position being processed, a next sampling position that is to be processed.

11. A graphics processor that is operable to generate a render output, the graphics processor comprising:
a rendering circuit that is operable to process primitives into respective sets of one or more fragments, each fragment associated with a respective set of one or more sampling positions within the render output, and which rendering circuit is further operable to process the resulting fragments to generate respective output values for the respective sampling positions within the render output; and
a rendering control circuit that is configured to control the operation of the graphics processor to generate a render output, wherein:
for a sequence of primitives to be processed for a render output:
the rendering control circuit causes the graphics processor to process the sequence of primitives by, using the rendering circuit:
performing an initial processing pass comprising processing primitives within the sequence of primitives into respective sets of one or more fragments, each fragment associated with a respective set of one or more sampling positions within the render output, and then processing the resulting fragments to determine which particular primitives in the sequence of primitives are visible for which sampling positions within the render output; and
thereafter performing a further processing pass to generate respective output values for the respective sampling positions within the render output, the further processing pass comprising, for each sampling position for which an output value is to be generated, generating a respective output value for the sampling position by performing further processing of the particular primitive in the sequence of primitives that is visible at that sampling position, wherein the rendering control circuit is further configured to:
when the graphics processor is performing a further processing pass for a sequence of primitives for which a corresponding initial processing pass has already been performed, wherein a set of information is generated from the processing of the sequence of primitives by the initial processing pass as to the further processing of primitives that is to be performed in respect of particular sampling positions within the render output when generating the respective output values for those particular sampling positions:
control an order in which sampling positions are processed for the further processing pass based on the set of information generated from the processing of the sequence of primitives by the corresponding initial processing pass.

12. The graphics processor of claim 11, wherein the generating of a respective output value for a sampling position by performing further processing of the particular primitive in the sequence of primitives that is visible at that sampling position includes applying graphics texture data associated with that particular primitive to the sampling position, and wherein the set of information is generated from the processing of the sequence of primitives by the initial processing pass is usable to identify which graphics texture data is to be applied at which sampling positions within the render output.

13. The graphics processor of claim 12, wherein the initial processing pass generates a set of primitive identifying information for the sequence of primitives, the set of primitive identifying information identifying for respective sampling positions in the render output the particular primitive that is visible at that sampling position, the graphics processor configured to:
process the set of primitive identifying information generated by an initial processing pass for a the sequence of primitives to determine a corresponding set of texture identifying information, the set of texture identifying information identifying for respective sampling positions in the render output particular graphics texture data that is to be applied for that sampling position.

14. The graphics processor of claim 12, wherein the rendering control circuit is configured to control an order in which the sampling positions are processed during the further processing pass by processing in consecutive order sampling positions within a group of sampling positions for which it has been identified that the same graphics texture data is to be applied.

15. The graphics processor of claim 12, wherein the graphics processor supports neural network based texture processing in which when graphics texture data is loaded into the graphics processor during the further processing pass, the graphics texture data is processed into a format for use by the graphics processor by one or more neural networks, and wherein the rendering control circuit is configured to control an order in which the sampling positions are processed during the further processing pass by processing in consecutive order sampling positions within a group of sampling positions for which it has been identified that some or all of the same neural network data or data structures are to be used.

16. The graphics processor of claim 11, wherein the generating of a respective output value for a sampling position by performing further processing of the particular primitive in the sequence of primitives that is visible at that sampling position includes executing one or more fragment shader, and wherein the set of information generated from the processing of the primitives during the initial processing pass is usable to identify which fragment shader is to be executed in respect of which sampling positions.

17. The graphics processor of claim 16, wherein the initial processing pass generates a set of primitive identifying information for the sequence of primitives, the set of primitive identifying information identifying for respective sampling positions in the render output the particular primitive that is visible at that sampling position, the graphics processor configured to:
process the set of primitive identifying information for the sequence of primitives to determine a corresponding set of texture identifying information, the set of texture identifying information identifying for respective sampling positions in the render output a particular fragment shader that is to be executed in respect of the processing for that sampling position.

18. The graphics processor of claim 16, wherein the rendering control circuit is configured to control an order in which the sampling positions are processed during the further processing pass by processing in consecutive order sampling positions within a group of sampling positions for which it has been identified that the same fragment shader is to be executed.

19. The graphics processor of claim 11, wherein controlling an order in which sampling positions are processed for a further processing pass comprises determining a desired order in which sampling positions are to be processed prior to starting the further processing pass.

20. The graphics processor of claim 11, wherein controlling an order in which sampling positions are processed for a further processing pass comprises determining, during the further processing pass, for a particular current sampling position being processed, a next sampling position that is to be processed.

21. A computer program product containing instructions that when executed by one or more processor will cause the one or more processor to perform a method of operating a graphics processor to generate a render output, the method comprising:
for a sequence of primitives to be processed for the render output:
performing an initial processing pass comprising processing primitives within the sequence of primitives into respective sets of one or more fragments, each fragment associated with a respective set of one or more sampling positions within the render output, and then processing the resulting fragments to determine which particular primitives in the sequence of primitives are visible for which sampling positions within the render output; and
thereafter performing a further processing pass to generate respective output values for the respective sampling positions within the render output, the further processing pass comprising, for each sampling position for which an output value is to be generated, generating a respective output value for the sampling position by performing further processing of the particular primitive in the sequence of primitives that is visible at that sampling position,
wherein a set of information is generated from the processing of the sequence of primitives by the initial processing pass as to the further processing of primitives that is to be performed in respect of particular sampling positions within the render output when generating the respective output values for those particular sampling positions, and wherein the method further comprises:
controlling an order in which the sampling positions are processed during the further processing pass based on the set of information generated from the processing of the sequence of primitives by the initial processing pass.
